(19) United States
(12) Patent Application Publication
(10) Pub. No.: US 2026/0082302 A1
(43) Pub. Date: Mar. 19, 2026

(54) INFORMATION REPORTING METHOD, USER EQUIPMENT, FIRST NETWORK SIDE DEVICE, AND STORAGE MEDIUM

(71) Applicant: VIVO MOBILE COMMUNICATION CO., LTD., Dongguan (CN)

(72) Inventor: Ranran HE, Dongguan (CN)

(73) Assignee: VIVO MOBILE COMMUNICATION CO., LTD., Dongguan (CN)

(21) Appl. No.: 19/397,830

(22) Filed: Nov. 21, 2025

Related U.S. Application Data
(63) Continuation of application No. PCT/CN2024/094043, filed on May 17, 2024.

(30) Foreign Application Priority Data
May 22, 2023 (CN) 202310583699.8

(51) Int. Cl. H04W 36/36; H04W 36/00

(52) U.S. Cl. CPC H04W 36/362; H04W 36/0058; H04W 36/0069

(57) ABSTRACT

An information reporting method, user equipment, a first network side device, and a storage medium, are provided. The method includes reporting first information to a first network side device. The first information is used to indicate at least one of the following: a radio link problem of a Master Cell Group (MCG) in a first process, or a radio link problem of a Secondary Cell Group (SCG) in the first process. The first process comprises at least one of the following: Conditional HandOver (CHO) with Conditional Primary secondary cell Addition (CPA); CHO with Conditional Primary secondary cell Change (CPC); CHO with primary secondary cell addition; or CHO with primary secondary cell change.

### CROSS-REFERENCE TO RELATED APPLICATIONS

This application is a continuation of International Application No. PCT/CN2024/094043, filed May 17, 2024, which claims priority to Chinese Patent Application No. 202310583699.8, filed May 22, 2023. The entire contents of each of the above-referenced applications are expressly incorporated herein by reference.

### TECHNICAL FIELD

This application is directed to the field of communication technologies, and specifically relates to an information processing method, user equipment, a first network side device, and a storage medium.

### BACKGROUND

Currently, a related technology supports Conditional HandOver (CHO) with primary secondary cell addition, or CHO with primary secondary cell change. In addition, the R18 protocol is discussing introducing CHO with Conditional Primary Secondary Cell Addition or Change (Conditional PSCell Addition or Change, CPAC). In a process in which User Equipment (UE) executes CHO with conditional primary secondary cell addition or change or CHO with CPAC, a connection failure may occur.

However, in a related technology, when only a Master Cell Group (MCG) fails, UE may store related information when a connection fails, and when the UE re-accesses a network, a Radio Link Failure (RLF) report may be reported based on an indication on a network side. When a Secondary Cell Group (SCG) fails, for example, PSCell change fails, if transmission of the MCG is not suspended, the UE may report related information indicating that the SCG fails. In other words, in the related technology, when the MCG fails or the SCG fails, the UE performs reporting separately. Therefore, in a process in which the UE has executed CHO with primary secondary cell addition or change or CHO with CPAC and when a connection failure occurs, how to enable the network side to learn that a reason of the connection failure is a problem to be solved.

### SUMMARY

Embodiments of this application provide an information reporting method, user equipment, a first network side device, and a storage medium.

According to a first aspect, an information reporting method is provided, and the method is performed by UE and includes: reporting, by the UE, first information to a first network side device; where the first information is used to indicate at least one of the following: a radio link problem of an MCG in a first process, and a radio link problem of an SCG in the first process; and the first process includes at least one of the following: CHO with conditional primary secondary cell addition CPA, CHO with conditional primary secondary cell change CPC, CHO with primary secondary cell addition, and CHO with primary secondary cell change.

According to a second aspect, an information reporting method is provided, and the method is performed by a first network side device and includes: receiving, by the first network side device, first information from UE; where the first information is used to indicate at least one of the following: a radio link problem of an MCG in a first process, and a radio link problem of an SCG in the first process; and the first process includes at least one of the following: CHO with CPA, CHO with CPC, CHO with primary secondary cell addition, and CHO with primary secondary cell change.

According to a third aspect, an information reporting apparatus is provided, and the apparatus includes a reporting module. The reporting module is configured to report first information to a first network side device; where the first information is used to indicate at least one of the following: a radio link problem of an MCG in a first process, and a radio link problem of an SCG in the first process; and the first process includes at least one of the following: CHO with CPA, CHO with CPC, CHO with primary secondary cell addition, and CHO with primary secondary cell change.

According to a fourth aspect, an information reporting apparatus is provided, and the apparatus includes a receiving module. The receiving module is configured to receive first information from UE; where the first information is used to indicate at least one of the following: a radio link problem of an MCG in a first process, and a radio link problem of an SCG in the first process; and the first process includes at least one of the following: CHO with CPA, CHO with CPC, CHO with primary secondary cell addition, and CHO with primary secondary cell change.

According to a fifth aspect, UE is provided. The UE includes a processor and a memory, the memory stores a program or instructions capable of being run on the processor, and when the program or the instructions are executed by the processor, the steps of the method according to the first aspect are implemented.

According to a sixth aspect, UE is provided, including a processor and a communication interface. The communication interface is configured to report first information to a first network side device; where the first information is used to indicate at least one of the following: a radio link problem of an MCG in a first process, and a radio link problem of an SCG in the first process; and the first process includes at least one of the following: CHO with CPA, CHO with CPC, CHO with primary secondary cell addition, and CHO with primary secondary cell change.

According to a seventh aspect, a first network side device is provided. The first network side device includes a processor and a memory, and the memory stores a program or instructions capable of being run on the processor. When the program or the instructions are executed by the processor, the steps of the method according to the second aspect are implemented.

According to an eighth aspect, a first network side device is provided, including a processor and a communication interface. The communication interface is configured to receive first information from UE; where the first information is used to indicate at least one of the following: a radio link problem of an MCG in a first process, and a radio link problem of an SCG in the first process; and the first process includes at least one of the following: CHO with CPA, CHO with CPC, CHO with primary secondary cell addition, and CHO with primary secondary cell change.

According to a ninth aspect, a readable storage medium is provided. The readable storage medium stores a program or instructions, and when the program or the instructions are executed by a processor, steps of the method according to the first aspect are implemented, or steps of the method according to the second aspect are implemented.

According to a tenth aspect, a communication system is provided, including UE and a first network side device. The UE may be configured to perform steps of the method according to the first aspect, and the first network side device may be configured to perform steps of the method according to the second aspect.

According to an eleventh aspect, a chip is provided. The chip includes a processor and a communication interface, the communication interface is coupled to the processor, and the processor is configured to run a program or instructions to implement the method according to the first aspect or the method according to the second aspect.

According to a twelfth aspect, a computer program product/program product is provided. The computer program product/program product is stored in a storage medium, and the program/program product is executed by at least one processor to implement steps of the information reporting method according to the first aspect or steps of the information reporting method according to the second aspect.

### BRIEF DESCRIPTION OF THE DRAWINGS

FIG. 1 is a schematic architectural diagram of a communication system according to an embodiment of this application;

FIG. 2 is a first flowchart of an information reporting method according to an embodiment of this application;

FIG. 3 is a second flowchart of an information reporting method according to an embodiment of this application;

FIG. 4 is a third schematic diagram of an information reporting method according to an embodiment of this application;

FIG. 5 is a first schematic diagram of a structure of an information reporting apparatus according to an embodiment of this application;

FIG. 6 is a second schematic diagram of a structure of an information reporting apparatus according to an embodiment of this application;

FIG. 7 is a third schematic diagram of a structure of an information reporting apparatus according to an embodiment of this application;

FIG. 8 is a fourth schematic diagram of a structure of an information reporting apparatus according to an embodiment of this application;

FIG. 9 is a schematic diagram of a hardware structure of a communication device according to an embodiment of this application;

FIG. 10 is a schematic diagram of a hardware structure of UE according to an embodiment of this application; and

FIG. 11 is a schematic diagram of a hardware structure of a first network side device according to an embodiment of this application.

### DETAILED DESCRIPTION

The following describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

Terms such as “first” and “second” in this application are used to distinguish between similar objects, and are not used to describe a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, “or” in this application represents at least one of connected objects. For example, “A or B” covers three solutions, that is, solution 1: including A and not including B; solution 2: including B and not including A; and solution 3: including A and B. The character “/” generally indicates an “or” relationship between associated objects.

The term “indication” in this application may be either a direct indication (or an explicit indication) or an indirect indication (or an implicit indication). A direct indication may be understood as: A transmitter explicitly notifies, in a transmitted indication, a receiver of content such as specific information, an operation that needs to be performed, or a request content. An indirect indication may be understood as: A receiver determines corresponding information based on an indication sent by a transmitter, or performs determining and determines, based on a determining result, an operation that needs to be performed, a request result, or the like.

It should be noted that technologies described in the embodiments of this application are not limited to a Long Term Evolution (LTE)/LTE-Advanced (LTE-A) system, and may further be applied to other wireless communication systems, such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may often be used interchangeably. The described technologies can be applied to the systems and the radio technologies mentioned above as well as to other systems and radio technologies. A New Radio (NR) system is described in the following description for illustrative purposes, and NR terms are used in most of the following description, although these technologies can also be applied to communication systems other than the NR system application, such as the 6th Generation (6G) communication system.

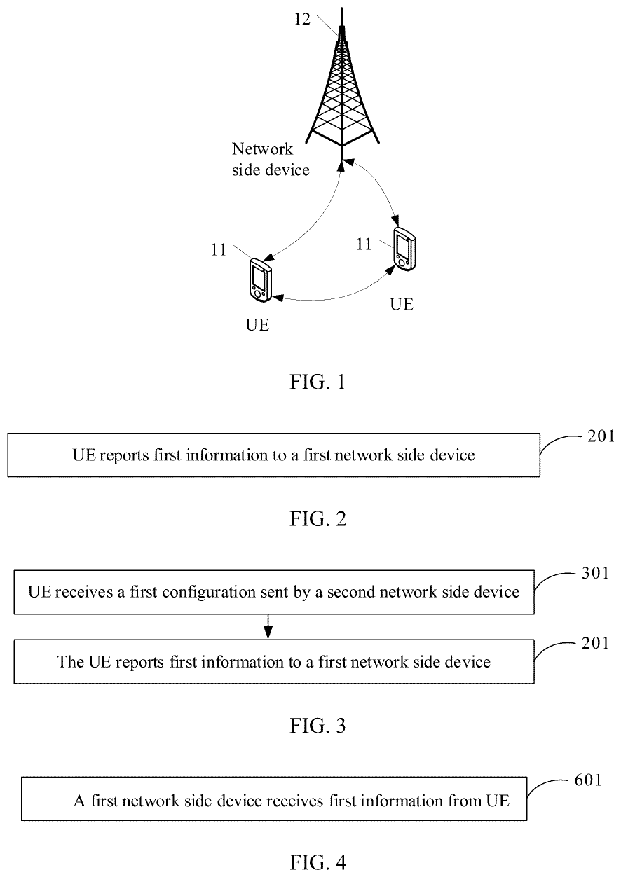

FIG. 1 is a block diagram of a wireless communication system to which embodiments of this application may be applied. The wireless communication system includes UE 11 and a first network side device 12. The UE 11 may be a terminal side device such as a mobile phone, a tablet personal computer, a laptop computer, a notebook computer, a Personal Digital Assistant (PDA), a palmtop computer, a netbook, an Ultra-Mobile Personal Computer (UMPC), a Mobile Internet Device (MID), an Augmented Reality (AR) device, a Virtual Reality (VR) device, a robot, a wearable device, a flight vehicle, Vehicle User Equipment (VUE), ship-borne equipment, Pedestrian User Equipment (PUE), a smart home device (a home device with a wireless communication function, such as a refrigerator, a television, a washing machine, or furniture), a game console, a personal computer, a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the UE 11 is not limited in this embodiment of this application. The first network side device 12 may include an access network device or a core network device. The access network device may also be referred to as a Radio Access Network (RAN) device, a radio access network function, or a radio access network unit. The access network device may include a base station, a Wireless Local Area Network (WLAN) Access Point (AS), a Wireless Fidelity (WiFi) node, and the like. The base station may be referred to as a NodeB (NB), an Evolved Node B (eNB), a next-generation node B (gNB), a New Radio Node B (NR Node B), an Access Point (AP), a Relay Base Station (RBS), a Serving Base Station (SBS), a Base Transceiver Station (BTS), a radio base station, a radio transceiver, a Basic Service Set (BSS), an Extended Service Set (ESS), a Home NodeB (HNB), a Home evolved NodeB (HeNB), a Transmission Reception Point (TRP), or another suitable term in the field, provided that a same technical effect is achieved, and the base station is not limited to a specific technical vocabulary. It should be noted that only a base station in an NR system is used as an example in this embodiment of this application for description, and a specific type of the base station is not limited.

Some concepts and/or terms involved in an information reporting method provided in embodiments of this application are explained and described below.

### I. Dual Connectivity (DC):

DC indicates providing resources of two network nodes (access network elements) for UE. One of the two network nodes is referred to as a Master node (MN), and the other network node is referred to as a Secondary node (SN). A Carrier Aggregation (CA) technology is used at each network node, that is, a series of serving cells controlled by the node are configured for the UE, and the series of serving cells are also referred to as a cell group. A cell group controlled by the MN is a Master Cell Group (MCG), and a cell group controlled by the SN is a Secondary Cell Group (SCG). Each cell group includes a Special Cell (SpCell) and a series of Secondary Cell (SCell). In the MCG, the special cell is referred to as a Primary Cell (PCell), and in the SCG, the special cell is referred to as a Primary Secondary Cell (PSCell). In one cell group, the SpCell uses a primary carrier, while another secondary cell uses a secondary carrier, and resource scheduling in one cell group is performed by the SpCell.

### II. Conditional HandOver (CHO)

To avoid a handover failure caused because UE cannot receive a handover command related message from a source node after a channel condition of a source cell deteriorates, a conditional handover procedure is introduced.

Main steps of a conditional handover process are as follows:
1. In a measurement process, the UE reports a measurement report.
2. The source node decides to use CHO.
3. The source node sends handover request information to one or more potential target nodes.
4. The target node may perform admission control.
5: The target node feeds back handover confirmation information to the source node.
6. The source node sends RRC reconfiguration (RRCReconfiguration) information that includes conditional handover to the UE.
7. The UE sends an RRCReconfigurationComplete message to the source node.
8. The UE evaluates whether a candidate cell satisfies a condition, and selects a target cell for handover after the condition is satisfied.
9. The UE initiates a random access process in the selected target cell.
10. The UE sends RRCReconfigurationComplete information to the target node.
11. After successfully completing the handover process, the UE releases a stored conditional handover configuration.
12. The target node sends a handover success message to the source node.
13. The source node sends a handover cancellation message to another candidate node.

### III. Conditional PSCell Addition or Change (CPAC)

### (1) Conditional PSCell Addition (CPA)

Conditional primary secondary cell addition is primary secondary cell addition performed after the UE evaluates an execution condition and the execution condition is satisfied.

A CPA configuration includes a configuration and an execution condition of a CPA candidate cell, and the execution condition may include one to two trigger conditions.

### (2) Conditional PSCell Change (CPC)

Conditional primary secondary cell change is primary secondary cell change performed after the UE evaluates an execution condition and the execution condition is satisfied. The UE starts to evaluate the execution condition after receiving a CPC configuration. The UE stops evaluating the execution condition after primary secondary cell change is triggered.

The CPC configuration includes a configuration and an execution conditions of a CPC candidate cell. The execution condition may include one or two trigger conditions. The UE releases all stored CPC configurations once a primary secondary cell change process is successfully completed.

The CPC includes a plurality of scenarios, such as:
1. Intra-Secondary Node Conditional Primary Secondary Cell Change (Intra-SN CPC);
2. Master Node initiated Inter-Secondary Node Conditional Primary Secondary Cell Change (MN initiated Inter-SN CPC); and
3. Secondary Node initiated Inter-Secondary Node Conditional Primary Secondary Cell Change (SN initiated Inter-SN CPC).

In some implementations, an intra-secondary node conditional primary secondary cell change procedure initiated by a secondary node includes the following steps:
1. A Source Secondary Node (Source-SN, S-SN) initiates CPAC.
2. A master node MN sends a secondary node addition request to at least one Target Secondary Node (Target-SN, T-SN).
3. The T-SN sends secondary node addition acknowledgement information including one or more candidate cell configurations to the MN.
4. The MN sends acceptance information for a candidate PSCell to the S-SN.
5. The S-SN updates CPAC configuration information.
6. The MN sends early data forwarding information.
7. The MN sends an RRC reconfiguration message including a CPAC command to the UE.
8. The UE sends a reconfiguration complete message, and acknowledges that the RRC reconfiguration message is received.
9. The UE triggers a CPAC execution condition, and sends an RRC reconfiguration complete message.
10. The MN sends an SN change acknowledgement message to the S-SN.
11. The MN sends a secondary node reconfiguration complete message to the T-SN.
12. The UE randomly accesses the T-SN.

Subsequent steps are omitted.

### IV. CHO+CPAC

Currently, a combination of CHO and CPAC is being discussed to implement a new conditional handover manner of CHO+CPAC or CHO with CPAC, that is, UE may receive two associated conditional configurations, one of which is CHO and the other is CPAC, and a PCell in the CHO configuration is associated with a PSCell in the CPAC configuration (for example, there is an interface between SNs), so that the UE can perform conditional evaluation on both the PCell and the PSCell, and hand over, at a proper occasion, to the PCell and the PSCell that satisfy a condition.

### V. RLF Report and SCG Failure Information

When an MCG fails, to enable a network side to analyze a reason of a connection failure and optimize a network side configuration, UE may store related information when the connection fails, and when the UE re-accesses a network, the UE may report an RLF report based on an instruction of the network side.

When an SCG fails (for example, a PSCell change fails), to enable the network side to analyze a reason of an SCG failure and optimize the network side configuration, if the transmission of the MCG is not suspended, the UE may report related information of the SCG failure.

An information reporting method provided in the embodiments of this application is described in detail below with reference to the accompanying drawings by using specific embodiments and application scenarios thereof.

Currently, the R17 protocol supports CHO with primary secondary cell addition, or CHO with primary secondary cell change. In addition, the R18 protocol is discussing introducing CHO with CPAC. In a process in which UE executes CHO with conditional primary secondary cell addition or change or CHO with CPAC, a connection failure may occur. In this case, how to make a network side learn a reason of the failure and optimize a configuration is not yet resolved.

In embodiments of this application, UE may report first information to a first network side device. The first information is used to indicate at least one of the following: a radio link problem of an MCG in a first process, and a radio link problem of an SCG in the first process. The first process includes at least one of the following: CHO with CPA, CHO with CPC, CHO with primary secondary cell addition, and CHO with primary secondary cell change. Therefore, the first network side device can learn a problem in a process in which the UE performs the first process, thereby learning a reason of a connection failure.

### Embodiment 1

An information reporting method is provided in this embodiment of this application. FIG. 2 is a flowchart of an information reporting method according to an embodiment of this application. As shown in FIG. 2, the information reporting method provided in this embodiment of this application may include the following step 201.

Step 201: UE reports first information to a first network side device.

The first information is used to indicate at least one of the following: a radio link problem of an MCG in a first process, and a radio link problem of an SCG in the first process.

In this embodiment of this application, the first process includes at least one of the following:
conditional handover CHO with conditional primary secondary cell addition CPA;
CHO with conditional primary secondary cell change CPC;
CHO with primary secondary cell addition; and
CHO with primary secondary cell change.

In this embodiment of this application, the first information is used to optimize a first configuration.

In some embodiments of this application, the first configuration includes at least one of the following:
a CHO configuration, where the CHO configuration includes a configuration of at least one CHO candidate cell, a configuration of one CHO candidate cell includes information about one CHO candidate cell and one first trigger condition, the first trigger condition is used by the UE to execute CHO, one first trigger condition corresponds to one CHO candidate cell, and the first trigger condition includes one or two events;
at least one first CPA configuration, where one first CPA configuration includes a configuration of at least one CPA candidate cell, a configuration of one CPA candidate cell includes information about one CPA candidate cell and a second trigger condition, the second trigger condition is used by the UE to execute CPA, one second trigger condition corresponds to one CPA candidate cell, and the second trigger condition includes one or two events;
at least one first CPC configuration, where one first CPC configuration includes a configuration of at least one CPC candidate cell, a configuration of one CPC candidate cell includes information about one CPC candidate cell and a third trigger condition, the third trigger condition is used by the UE to execute CPC, the third trigger condition corresponds to one CPC candidate cell, and the third trigger condition includes one or two events;
a configuration of primary secondary cell addition; and
a configuration of primary secondary cell change; where
one first CPA configuration is associated with a configuration of one CHO candidate cell, one first CPC configuration is associated with a configuration of one CHO candidate cell, the configuration of primary secondary cell addition is associated with a configuration of one CHO candidate cell, and the configuration of primary secondary cell change is associated with a configuration of one CHO candidate cell.

In some embodiments of this application, the first trigger condition may be understood as a condition for the UE to execute CHO, where one first trigger condition corresponds to one CHO candidate cell, and one first trigger condition may include one or two events, for example, condEvent A3 and condEvent A5; the second trigger condition may be understood as a condition for the UE to execute CPA, where one second trigger condition corresponds to one CPA candidate cell, and the second trigger condition may include one or two events, for example, condEvent A3 and condEvent A4; and the third trigger condition may be understood as a condition for the UE to execute CPC, where one third trigger condition corresponds to one CPC candidate cell, and one third trigger condition may include one or two events, for example, condEvent A3 and condEvent A5.

It should be noted that after the UE reports the first information to the first network side device, for description of how to optimize the first configuration, reference may be made to description in Embodiment 2 below. Details are not described herein again.

This embodiment of this application provides an information reporting method. UE may report first information to a first network side device. The first information is used to indicate at least one of the following: a radio link problem of an MCG in a first process, and a radio link problem of an SCG in the first process. The first process includes at least one of the following: CHO with CPA, CHO with CPC, CHO with primary secondary cell addition, and CHO with primary secondary cell change. Therefore, the first network side device can learn a problem in a process in which the UE performs the first process, thereby learning a reason of a connection failure.

In some embodiments of this application, as shown in FIG. 3, before step 201, the information reporting method provided in this embodiment of this application further includes the following step 301.

Step 301: The UE receives a first configuration sent by a second network side device.

In this embodiment of this application, the first configuration is used to configure the UE to perform the first process.

In some embodiments of this application, the second network side device may be a device that is the same as the first network side device, or the second network side device may be a device that is different from the first network side device.

It may be understood that after receiving the first configuration, the UE may perform, based on the first configuration, an evaluation and execution procedure related to the first process, and then report the first information to the first network side device, so as to indicate a problem in a process of performing the first process, so that a network side optimizes the first configuration.

In some embodiments of this application, step 201 may be implemented by the following step 201a, step 201b, or step 201c.

Step 201a: The UE reports second information to the first network side device in a case that a first condition is satisfied.

In this embodiment of this application, the first information includes the second information.

In this embodiment of this application, the first condition is related to at least one of the following: the UE has not executed CPA or CPC, and the UE has executed CPA or CPC. The second information is used to indicate a radio link problem of the SCG in a case that the UE successfully executes CHO.

In some embodiments of this application, after receiving the CHO configuration and the at least one first CPA configuration, the UE may evaluate a trigger condition for CHO and a trigger condition for CPA. If the trigger condition for CHO is satisfied, and the trigger condition for CPA is not satisfied, the UE executes CHO and still uses the CPA configuration. When/after CHO is completed, the UE may report the second information to the first network side device.

In some embodiments of this application, after receiving the CHO configuration and the at least one first CPC configuration, the UE may evaluate a trigger condition for CHO and a trigger condition for CPC. If the trigger condition for CHO is satisfied, and the trigger condition for CPC is not satisfied, the UE executes CHO and still uses the CPC configuration. When/after CHO is completed, the UE may report the second information to the first network side device.

In some implementations, the first condition includes at least one of the following:
the UE is configured with a first configuration;
the UE is configured to be required to report the second information;
the UE is enabled to report the second information;
no CPA candidate cell satisfies the second trigger condition at first time;
no CPC candidate cell satisfies the third trigger condition at the first time;
the UE has not executed the CPA at the first time;
the UE has not executed the CPC at the first time;
no CPA candidate cell satisfies the second trigger condition before second time;
no CPC candidate cell satisfies the third trigger condition before the second time;
the UE has not executed the CPA at the second time;
the UE has not executed the CPC at the second time;
a first time interval exceeds a first threshold;
no CPA candidate cell satisfies the second trigger condition before the first time, and the second trigger condition for CPA is satisfied at third time;
the UE has not executed the CPA at the first time, and the UE has executed the CPA at the third time;
no CPA candidate cell satisfies the second trigger condition before the second time, and the second trigger condition for CPA is satisfied at the third time;
the UE has not executed the CPA at the second time, and the UE has executed the CPA at the third time;
no CPC candidate cell satisfies the third trigger condition before the first time, and the third trigger condition for CPC is satisfied at the third time;
the UE has not executed the CPC at the first time, and the UE has executed the CPC at the third time;
no CPC candidate cell satisfies the third trigger condition before the second time, and the third trigger condition for CPC is satisfied at the third time; and
the UE has not executed the CPC at the second time, and the UE has executed the CPC at the third time; where
the third time is time after the second time, and the second time is time after the first time.

In some embodiments of this application, the second information includes at least one of the following:
first indication information, where the first indication information is used to indicate at least one of the following: no CPA candidate cell satisfies the second trigger condition at first time, and the UE has not executed the CPA at the first time;
second indication information, where the second indication information is used to indicate at least one of the following: no CPC candidate cell satisfies the third trigger condition at the first time, and the UE has not executed the CPC at the first time;
third indication information, where the third indication information is used to indicate at least one of the following: no CPA candidate cell satisfies the second trigger condition at second time, and the UE has not executed the CPA at the second time;
fourth indication information, where the fourth indication information is used to indicate at least one of the following: no CPC candidate cell satisfies the third trigger condition at the second time, and the UE has not executed the CPC at the second time;
a first time interval;
a second time interval;
fifth indication information, where the fifth indication information is used to indicate that a source SCG fails or does not fail when the UE executes the CHO to a first cell;
sixth indication information, where the sixth indication information is used to indicate that a first timer used for the SCG when the UE executes the CHO to the first cell is running or has not been started;
seventh indication information, where the seventh indication information is used to indicate a running status of the first timer used for the SCG when the UE executes the CHO to the first cell;
a measurement result of a second cell at the first time;
a measurement result of the second cell at the second time;
at least one piece of eighth indication information, where each piece of eighth indication information in the at least one piece of eighth indication information is used to indicate that the second cell is a CPA candidate cell or is not a CPA candidate cell;
at least one piece of ninth indication information, where each piece of ninth indication information in the at least one piece of ninth indication information is used to indicate that the second cell is a CPC candidate cell or is not a CPC candidate cell;
a satisfaction status of the second trigger condition for each CPA candidate cell at the first time;
a satisfaction status of the third trigger condition for each CPC candidate cell at the first time;
the second trigger condition for each CPA candidate cell;
the third trigger condition for each CPC candidate cell; and
information about the first cell.

In some embodiments of this application, the first cell is a target cell to which the UE executes CHO.

In some embodiments of this application, the second cell includes at least one of the following: a neighboring cell of a current serving cell before the UE executes CHO, and a neighboring cell of a current serving cell after the UE executes CHO.

In some embodiments of this application, the measurement result includes at least one of the following: Reference Signal Receive Power (RSRP), Reference Signal Receive Quality (RSRQ), and a Signal-to-Interference-plus-Noise Ratio (SINR).

In some embodiments of this application, the first time includes at least one of the following:
time at which the UE executes the CHO to the first cell;
time at which the UE completes execution of the CHO to the first cell; and
time at which a first trigger condition for at least one CHO candidate cell is satisfied, where the at least one CHO candidate cell includes the first cell.

In some embodiments of this application, the second time is time represented by the second time interval that is after the first time.

In some implementations, the second time interval may be indicated by using duration, that is, the second time may be time indicated by the first time+the duration. The duration may be configured by a network side (for example, configured by using RRCReconfiguration, or in particular, indicated by an otherConfig field in RRCReconfiguration), or agreed upon in a protocol, where a unit may be second/millisecond/microsecond/frame/subframe/slot.

In some embodiments of this application, the second time interval is time elapsed from the first time to the second time, that is, duration configured by a network side or agreed upon in a protocol.

In some embodiments of this application, the first time interval is time elapsed from the first time and fourth time.

In some embodiments of this application, the fourth time includes at least one of the following:
time at which the UE executes the CPA to a third cell;
time at which the UE executes the CPC to a fourth cell;
time at which the UE completes execution of the CPA to the third cell;
time at which the UE completes execution of the CPC to the fourth cell;
time at which the second trigger condition for at least one CPA candidate cell is satisfied; and
time at which the third trigger condition for at least one CPC candidate cell is satisfied.

In some embodiments of this application, the third cell is a target cell to which the UE executes CPA, and the fourth cell is a target cell to which the UE executes CPC.

In some embodiments of this application, the CPA candidate cell is associated with the first cell, and the CPC candidate cell is associated with the first cell.

In some embodiments of this application, the first timer includes at least one of the following: a T310 timer and a T312 timer.

In some embodiments of this application, the running status of the first timer may be represented by a percentage/score, or may be represented by a specific value, which is not limited in this embodiment of this application.

For example, T310 used for the SCG is configured as 100 ms. If the seventh indication information is represented by using a specific value, for example, 80 ms, it indicates that T310 used for the SCG has already run for 80 ms when the second information is generated. Additionally, the network side device may calculate, by using the seventh indication information reported by the UE and configured T310 used for the SCG, that T310 used for the SCG has already run to 80%. If the seventh indication information is represented by a percentage, for example, 80%, it indicates that T310 used for the SCG has run to 80% when the second information is generated. Additionally, the network side device may calculate, by using the seventh indication information reported by the UE and configured T310 used for the SCG, that T310 used for the SCG has run for 80 ms.

In some embodiments of this application, a satisfaction status of the second trigger condition for the CPA candidate cell includes at least one of the following:
a 1^{st} event in the second trigger condition is satisfied first;
a 2^{nd} event in the second trigger condition is satisfied first;
time elapsed from time at which the 1^{st} event in the second trigger condition is satisfied to time at which the 2^{nd} event is satisfied; and
a difference between a first measurement result and the second trigger condition in a case that the second trigger condition is not satisfied, where the first measurement result includes a measurement result of the CPA candidate cell; and
a satisfaction status of the third trigger condition for the CPC candidate cell includes at least one of the following:
a 1^{st} event in the third trigger condition is satisfied first;
a 2^{nd} event in the third trigger condition is satisfied first;
time elapsed from time at which the 1^{st} event in the third trigger condition is satisfied to time at which the 2^{nd} event is satisfied; and
a difference between a second measurement result and the third trigger condition in a case that the third trigger condition is not satisfied. The second measurement result includes at least one of the following: a measurement result of a source primary secondary cell and a measurement result of the CPC candidate cell.

In some embodiments of this application, the information about the first cell includes at least one of the following:
a physical cell IDentifier (ID);
a cell ID;
a Cell Global Identity (CGI);
a 1^{st} network identifier broadcast in the first cell; and
an identifier of a tracking area to which the first cell belongs, where the identifier of the tracking area is associated with the 1^{st} network identifier broadcast in the first cell.

It may be understood that, CPC is used as an example. If the third trigger condition includes one event, for example, condEvent A3, in a case that the third trigger condition is not satisfied, the second measurement result includes the measurement result of the CPC candidate cell, the difference between the second measurement result and the third trigger condition is a difference between the measurement result and the third trigger condition (that is, condEvent A3) corresponding to the CPC candidate cell and may be a difference between a first difference and condEvent A3, where the first difference is a difference between the measurement result of the CPC candidate cell and a source PSCell.

If the third trigger condition includes two events, for example, condEvent A3 and condEvent A5, the difference between the second measurement result and the third trigger condition refers to a difference between the measurement result and the third trigger condition (that is, respectively, condEvent A3 and condEvent A5) corresponding to the CPC candidate cell, and may for a difference from condEvent A3, the difference is a difference between a first difference and condEvent A3, where the first difference is a difference between the measurement result of the CPC candidate cell and a source PSCell; and for a difference from condEvent A5, the difference is a difference between the measurement result of the CPC candidate cell and a first offset in condEvent A5, and a difference between a measurement result of the source PSCell and a second offset in condEvent A5, where the first offset is an offset of the CPC candidate cell, and the second offset is an offset of the source PSCell.

It should be noted that for specific description of the difference between the first measurement result and the second trigger condition, the difference between the third measurement result and the first trigger condition, and the difference between the fourth measurement result and the first trigger condition, reference may be made to the foregoing description of the difference between the second measurement result and the third trigger condition. Details are not described herein again.

In some embodiments of this application, if a process in which the UE reports the second information to the first network side device is delayed reporting (that is, storing before reporting based on an indication), through reporting of the information of the first cell, a network side device that receives the second information can be assisted in forwarding the second information to a network side device corresponding to the first cell.

In some embodiments of this application, the second information further includes at least one of the following:
second information obtained most recently before the first time;
second information obtained most recently before the second time; and
second information obtained most recently before third time.

In some embodiments of this application, that “the UE reports second information to the first network side device” in step 201a may be implemented by using the following step 201a1, step 201a2, or step 201a3.

Step 201a1: In a case that the first condition is satisfied, the UE carries the second information by using a CHO handover complete message.

It may be understood that, when handover is completed, the UE carries the second information by using an RRCReconfigurationComplete message.

Step 201a2: In a case that the first condition is satisfied, the UE triggers a process of reporting SCG failure information, and carries the second information by using the SCG failure information.

It may be understood that the UE carries the second information by using an SCGFailureInformation message.

Step 201a3: In a case that the first condition is satisfied, the UE stores the second information into a first variable, and carries the second information by using a first message based on an instruction of the first network side device.

It may be understood that the first message may be a UEInformationResponse message or a newly introduced RRC message.

In some embodiments of this application, that “the UE stores the second information into a first variable, and carries the second information by using a first message based on an instruction of the first network side device” in step 201a3 may be implemented by using the following steps 401 to 403.

Step 401: The UE stores the second information into the first variable.

In some embodiments of this application, the UE may further store a first list, where the first list includes an identifier of a network registered with by the UE, a selected network, and an identifier of a network equivalent to a registered network when the UE generates/records the second information.

Step 402: The UE sends tenth indication information to the first network side device.

In this embodiment of this application, the tenth indication information is used to indicate that there is available second information in the first variable.

In some embodiments of this application, in a case that the first list in the first variable includes an identifier of a network currently registered with by the UE, the UE sends the tenth indication information to the first network side device.

In some embodiments of this application, the tenth indication information may be carried in an RRC complete message, for example, an RRC reconfiguration complete message, an RRC re-establishment complete message, an RRC recovery complete message, and an RRC setup complete message.

Step 403: The UE sends a first message to the first network side device in a case that eleventh indication information sent by the first network side is received.

In this embodiment of this application, the second information is carried in the first message, and the eleventh indication information is used to instruct the UE to report the second information.

In some embodiments of this application, in a case that the first list in the first variable includes the identifier of the network currently registered with by the UE, the UE sends the first message to the first network side device.

In some embodiments of this application, in a case that the UE sets a value of the second information in the first message to a value of the second information in the first variable, the UE sends the first message to the first network side device.

In some embodiments of this application, the first message is a UEInformationResponse message, and the second information is a successHO-Report or a Successful PSCell change/addition Report (SPR).

In this way, flexibility of reporting the second information to the first network side device by the UE is improved.

Step 201b: The UE reports third information to the first network side device in a case that a second condition is satisfied.

In this embodiment of this application, the first information includes the third information.

In this embodiment of this application, the second condition is related to at least one of the following: the UE has executed CHO and the UE has not executed CHO, and the third information is used to indicate a radio link problem of the SCG when the UE has not executed CHO.

In some embodiments of this application, after receiving the CHO configuration and at least one first CPA configuration, the UE evaluates a trigger condition for CHO and a trigger condition for CPA. If the trigger condition for CPA is satisfied and the trigger condition for CHO is not satisfied, based on a CHO with CPA mechanism, the UE cannot execute CPA. If a radio link problem (for example, an SCG failure) occurs in the SCG, the UE may report the third information to the first network side device.

In some embodiments of this application, after receiving the CHO configuration and the at least one first CPC configuration, the UE may evaluate a trigger condition for CHO and a trigger condition for CPC. If the trigger condition for CPC is satisfied and the trigger condition for CHO is not satisfied, based on a CHO with CPC mechanism, the UE cannot execute CPC. If a radio link problem (for example, an SCG failure) occurs in the SCG, the UE may report the third information to the first network side device.

In some implementations, the second condition includes at least one of the following:
the UE is configured with a first configuration;
the UE is configured to be required to report the third information;
the UE is enabled to report the third information;
at least one CPA candidate cell satisfies the second trigger condition, a fifth cell does not satisfy the first trigger condition, the CPA candidate cell is associated with the fifth cell, and the fifth cell is one of CHO candidate cells;
at least one CPC candidate cell satisfies the third trigger condition, a sixth cell does not satisfy the first trigger condition, the CPC candidate cell is associated with the sixth cell, and the sixth cell is one of CHO candidate cells;
the SCG fails;
a first timer used for the SCG has been started;
running duration of the first timer used for the SCG exceeds a second threshold;
the MCG fails;
a second timer for the MCG has been started; and
running duration of the second timer used for the MCG exceeds a third threshold.

In some embodiments of this application, the second timer includes at least one of the following: a T310 timer and a T312 timer.

In some embodiments of this application, the third information includes at least one of the following:
information about at least one seventh cell, where one seventh cell is a CPA candidate cell, and one seventh cell satisfies the second trigger condition;
information about at least one eighth cell, where one eighth cell is a CPC candidate cell, and one eighth cell satisfies the third trigger condition;
a satisfaction status of a first trigger condition for a fifth cell, where the fifth cell is a CHO candidate cell, and the fifth cell is associated with all seventh cells;
a satisfaction status of a first trigger condition for a sixth cell, where the sixth cell is a CHO candidate cell, and the sixth cell is associated with all eighth cells;
the first trigger condition for the fifth cell;
the first trigger condition for the sixth cell;
a measurement result of the fifth cell, where the measurement result includes at least one of the following: RSRP, RSRQ, and a SINR;
a measurement result of the sixth cell, where the measurement result includes at least one of the following: RSRP, RSRQ, and a SINR;
a measurement result of a neighboring cell of a current serving cell; and
information about a ninth cell, where the ninth cell is a primary cell connected to the UE when the third information is generated.

In some embodiments of this application, information about one seventh cell includes at least one of the following:
a physical cell ID;
a cell ID;
a CGI;
a 1^{st} network identifier broadcast in one seventh cell; and
an identifier of a tracking area to which one seventh cell belongs, where the identifier of the tracking area is associated with the 1^{st} network identifier broadcast in one seventh cell.

In some embodiments of this application, information about one eighth cell includes at least one of the following:
a physical cell ID;
a cell ID;
a CGI;
a 1^{st} network identifier broadcast in one eighth cell; and
an identifier of a tracking area to which one eighth cell belongs, where the identifier of the tracking area is associated with the 1^{st} network identifier broadcast in one eighth cell.

In some embodiments of this application, one seventh cell may satisfy the second trigger condition or one eighth cell may satisfy the third trigger condition at any time before/when the second condition is satisfied.

In some embodiments of this application, the satisfaction status of the first trigger condition for the fifth cell includes at least one of the following:
a 1^{st} event in the first trigger condition is satisfied first;
a 2^{nd} event in the first trigger condition is satisfied first;
time elapsed from time at which the 1^{st} event in the first trigger condition is satisfied to time at which the 2^{nd} event is satisfied; and
a difference between a third measurement result and the first trigger condition in a case that the first trigger condition is not satisfied, where the third measurement result includes at least one of the following: a measurement result of the fifth cell, and a measurement result of a primary cell.

In some embodiments of this application, the satisfaction status of the first trigger condition for the sixth cell includes at least one of the following:
a 1^{st} event in the first trigger condition is satisfied first;
a 2^{nd} event in the first trigger condition is satisfied first;
time elapsed from time at which the 1^{st} event in the first trigger condition is satisfied to time at which the 2^{nd} event is satisfied; and
a difference between a fourth measurement result and the first trigger condition in a case that the first trigger condition is not satisfied, where the fourth measurement result includes at least one of the following: a measurement result of the sixth cell, and a measurement result of a primary cell.

In some embodiments of this application, the measurement result of the neighboring cell includes at least one of the following:
a signal measurement result of the neighboring cell, where the signal measurement result includes at least one of the following: RSRP, RSRQ, and a SINR;
twelfth indication information, where the twelfth indication information is used to indicate whether the neighboring cell is a CHO candidate cell;
thirteenth indication information, where the thirteenth indication information is used to indicate whether the neighboring cell is a CPA candidate cell;
fourteenth indication information, where the fourteenth indication information is used to indicate whether the neighboring cell is a CPC candidate cell;
fifteenth indication information, where in a case that the neighboring cell is a CHO candidate cell, the fifteenth indication information is used to indicate whether the neighboring cell satisfies the first trigger condition; in a case that the neighboring cell is a CPA candidate cell, the fifteenth indication information is used to indicate whether the neighboring cell satisfies the second trigger condition; and in a case that the neighboring cell is a CPC candidate cell, the fifteenth indication information is used to indicate whether the neighboring cell satisfies the third trigger condition;
a first association relationship, where the first association relationship is used to indicate an association relationship between the CHO candidate cell and the CPA candidate cell; and
a second association relationship, where the second association relationship is used to indicate an association relationship between the CHO candidate cell and the CPC candidate cell.

In some embodiments of this application, the information about the ninth cell includes at least one of the following:
cell identity related information of the ninth cell, where the cell identity related information includes at least one of the following: a physical cell ID, a cell ID, a CGI, a 1^{st} network identity broadcast in the ninth cell, and an identifier of a tracking area to which the ninth cell belongs, where the identifier of the tracking area is associated with the 1^{st} network identity broadcast in the ninth cell; and
link status related information, where the link status related information includes at least one of the following:
sixteenth indication information, where the sixteenth indication information is used to indicate that a second timer used for the MCG is running or has not been started;
seventeenth indication information, where the seventeenth indication information is used to indicate a running status of the second timer used for the MCG; and
eighteenth indication information, where the eighteenth indication information is used to indicate whether a radio link failure occurs in the ninth cell.

In some embodiments of this application, the first timer includes at least one of the following: a T310 timer and a T312 timer, and the second timer includes at least one of the following: a T310 timer and a T312 timer.

In some embodiments of this application, the third information further includes at least one of the following:
third information obtained most recently before the SCG fails;
third information obtained when the at least one CPA candidate cell satisfies the second trigger condition; and
third information obtained when the at least one CPC candidate cell satisfies the third trigger condition.

In some embodiments of this application, that “the UE reports third information to the first network side device” in step 201b may be implemented by using the following step 201b1 or step 201b2.

Step 201b1: In a case that the second condition is satisfied, the UE triggers a process of reporting SCG failure information, and carries the third information by using the SCG failure information.

It may be understood that the UE carries the third information by using an SCGFailureInformation message.

Step 201b2: In a case that the second condition is satisfied, the UE stores the third information into a second variable, and carries the third information by using a second message based on an instruction of the first network side device

In some embodiments of this application, that “the UE stores the third information into the second variable, and carries the third information by using the second message based on an instruction of the first network side device” in step 201b2 may be implemented by using the following steps 501 to 503.

Step 501: The UE stores the third information into the second variable.

In some embodiments of this application, the third information includes a second list, and the second list includes an identifier of a network registered with by the UE, a selected network, and an identifier of a network equivalent to a registered network when the UE generates/records the third information.

Step 502: The UE sends nineteenth indication information to the first network side device.

In this embodiment of this application, the nineteenth indication information is used to indicate that there is available third information in the second variable.

In some embodiments of this application, in a case that the second list in the second variable includes an identifier of a network currently registered with by the UE, the UE sends the nineteenth indication information to the first network side device.

In some embodiments of this application, the nineteenth indication information may be carried in an RRC complete message, for example, an RRC reconfiguration complete message, an RRC re-establishment complete message, an RRC recovery complete message, and an RRC setup complete message.

Step 503: In a case that twentieth indication information sent by the first network side is received, the UE sends a second message to the first network side device.

In this embodiment of this application, the third information is carried by using the second message, and the twentieth indication information is used to instruct the UE to report the third information.

In some embodiments of this application, in a case that the second list in the second variable includes the identifier of the network currently registered with by the UE, the UE sends the second message to the first network side device.

In some embodiments of this application, in a case that the UE sets a value of the third information in the second message to a value of the third information in the second variable, the UE sends the second message to the first network side device.

In some embodiments of this application, the second message is UEInformationResponse.

In this way, flexibility of reporting the third information to the first network side device by the UE is improved.

Step 201c: The UE reports fourth information to the first network side device in a case that a third condition is satisfied.

In this embodiment of this application, the first information includes the fourth information.

In this embodiment of this application, the third condition is related to a CHO execution failure of the UE, and the fourth information is used to indicate at least one of the following: a radio link problem of the MCG in a case that the UE has executed CHO and the CHO fails, and a radio link problem of the SCG in a case that the UE has executed CHO and the CHO fails.

In some embodiments of this application, after receiving the CHO configuration and a configuration of primary secondary cell addition, the UE may evaluate a trigger condition for CHO. If the trigger condition for CHO is satisfied, the UE executes CHO. However, if there is an MCG failure, the UE may report the fourth information to the first network side device.

In some embodiments of this application, after receiving the CHO configuration and a configuration of primary secondary cell change, the UE may evaluate a trigger condition for CHO. If the trigger condition for CHO is satisfied, the UE executes CHO. However, if there is an MCG failure, the UE may report the fourth information to the first network side device.

In some embodiments of this application, after receiving the CHO configuration and the at least one first CPA configuration, the UE may evaluate a trigger condition for CHO. If the trigger condition for CHO is satisfied, the UE executes CHO. However, if there is an MCG failure, the UE may report the fourth information to the first network side device.

In some embodiments of this application, after receiving the CHO configuration and the at least one first CPC configuration, the UE may evaluate a trigger condition for CHO. If the trigger condition for CHO is satisfied, the UE executes CHO. However, if there is an MCG failure, the UE may report the fourth information to the first network side device.

In some implementations, the third condition includes at least one of the following:
the UE is configured with a first configuration;
the UE is configured to be required to report the fourth information;
the UE is enabled to report the fourth information; and
the MCG fails.

In some embodiments of this application, the fourth information includes at least one of the following:
information about at least one tenth cell, where one tenth cell is a CPA candidate cell, and one tenth cell satisfies the second trigger condition;
information about at least one eleventh cell, where one eleventh cell is a CPC candidate cell, and one eleventh cell satisfies the third trigger condition;
a measurement result of a neighboring cell of a current serving cell;
related information of a source SCG link status when the UE executes the CHO to a first cell, where the first cell is a target cell to which the UE executes the CHO;
twenty-first indication information, where the twenty-first indication information is used to indicate whether the UE has executed the CPA;
twenty-second indication information, where the twenty-second indication information is used to indicate whether the CPA succeeds;
twenty-third indication information, where the twenty-third indication information is used to indicate whether the UE has executed the CPC;
twenty-fourth indication information, where the twenty-fourth indication information is used to indicate whether the CPC succeeds;
twenty-fifth indication information, where the twenty-fifth indication information is used to indicate whether the UE has executed primary secondary cell addition;
twenty-sixth indication information, where the twenty-sixth indication information is used to indicate whether the UE has executed primary secondary cell change;
twenty-seventh indication information, where the twenty-seventh indication information is used to indicate whether the primary secondary cell addition succeeds;
twenty-eighth indication information, where the twenty-eighth indication information is used to indicate whether the primary secondary cell change succeeds;
a satisfaction status of the second trigger condition for the CPA candidate cell when the fourth information is generated; and
a satisfaction status of the third trigger condition for the CPC candidate cell when the fourth information is generated.

In some embodiments of this application, the CPA candidate cell is associated with the first cell, and the CPC candidate cell is associated with the first cell.

In some embodiments of this application, information about one tenth cell includes at least one of the following:
a physical cell ID;
a cell ID;
a CGI;
a 1^{st} network identifier broadcast in one tenth cell; and
an identifier of a tracking area to which one tenth cell belongs, where the identifier of the tracking area is associated with the 1^{st} network identifier broadcast in one tenth cell.

In some embodiments of this application, information about one eleventh cell includes at least one of the following:
a physical cell ID;
a cell ID;
a CGI;
a 1^{st} network identifier broadcast in one eleventh cell; and
an identifier of a tracking area to which one eleventh cell belongs, where the identifier of the tracking area is associated with the 1^{st} network identifier broadcast in one eleventh cell.

It should be noted that for description of the measurement result of the neighboring cell of the current serving cell, reference may be made to the description in the foregoing step. Details are not described herein again.

In some embodiments of this application, the related information of the source SCG link status when the UE is indicated to execute the CHO to the first cell includes at least one of the following:
information indicating that a source SCG fails or does not fail when the UE executes the CHO to the first cell;
information indicating that a first timer used for the SCG is running or has not been started when the UE executes the CHO to the first cell; and
information indicating a running status of the first timer used for the SCG when the UE executes the CHO to the first cell.

In some embodiments of this application, the first timer includes at least one of the following: a T310 timer and a T312 timer.

In some embodiments of this application, the running status of the first timer may be represented by a percentage/score, or may be represented by a specific value, which is not limited in this embodiment of this application.

In some embodiments of this application, the first timer includes at least one of the following: a T310 timer and a T312 timer.

In some embodiments of this application, a satisfaction status of the second trigger condition for the CPA candidate cell includes at least one of the following:
a 1^{st} event in the second trigger condition is satisfied first;
a 2^{nd} event in the second trigger condition is satisfied first;
time elapsed from time at which the 1^{st} event in the second trigger condition is satisfied to time at which the 2^{nd} event is satisfied; and
a difference between a first measurement result and the second trigger condition in a case that the second trigger condition is not satisfied, where the first measurement result includes a measurement result of the CPA candidate cell.

In some embodiments of this application, a satisfaction status of the third trigger condition for the CPC candidate cell includes at least one of the following:
a 1^{st} event in the third trigger condition is satisfied first;
a 2^{nd} event in the third trigger condition is satisfied first;
time elapsed from time at which the 1^{st} event in the third trigger condition is satisfied to time at which the 2^{nd} event is satisfied; and
a difference between a second measurement result and the third trigger condition in a case that the third trigger condition not satisfied, where the second measurement result includes at least one of the following: a measurement result of a source primary secondary cell, and a measurement result of the CPC candidate cell.

In some embodiments of this application, the fourth information further includes at least one of the following: the second trigger condition and the third trigger condition.

In some embodiments of this application, the fourth information further includes at least one of the following:
fourth information obtained during a most recent MCG failure;
fourth information obtained during a CHO failure; and
fourth information obtained during each of two CHO failures.

In some embodiments of this application, each set of fourth information is associated with failedPCellId and choCellId, where failedPCellId is a target primary cell that fails to be handed over to, and choCellId is a cell selected by the UE during CHO based recovery.

In some embodiments of this application, that “the UE reports fourth information to the first network side device” in step 201c may be implemented by using the following step 201cl or step 201c2.

Step 201c1: The UE sends an RLF report to the first network side device.

In this embodiment of this application, the RLF report includes the fourth information.

It may be understood that the UE includes the fourth information in RLF-Report-r16.

Step 201c2: The UE sends an information response message to the first network side device.

In this embodiment of this application, a first domain of the information response message includes the fourth information.

In some embodiments of this application, the UE introduces a new domain to include the fourth information, and reports the fourth information by using a UEInformationRequest-UEInformationResponse process.

In this way, flexibility of reporting the fourth information to the first network side device by the UE is improved.

### Embodiment 2

An information reporting method is provided in this embodiment of this application. FIG. 4 is a flowchart of an information reporting method according to an embodiment of this application. As shown in FIG. 4, the information reporting method provided in this embodiment of this application may include the following step 601.

Step 601: A first network side device receives first information from UE.

The first information is used to indicate at least one of the following: a radio link problem of an MCG in a first process, and a radio link problem of an SCG in first process.

In this embodiment of this application, the first process includes at least one of the following:
CHO with CPA;
CHO with CPC;
CHO with primary secondary cell addition; and
CHO with primary secondary cell change.

In some embodiments of this application, the first information is used to optimize a first configuration, and the first configuration is used to configure the UE to perform the first process.

This embodiment of this application provides an information reporting method. A first network side device may receive first information from UE. The first information is used to indicate at least one of the following: a radio link problem of an MCG in a first process, and a radio link problem of an SCG in the first process. The first process includes at least one of the following: CHO with CPA, CHO with CPC, CHO with primary secondary cell addition, and CHO with primary secondary cell change. Therefore, the first network side device can learn a problem in a process in which the UE performs the first process, thereby learning a reason of a connection failure.

In some embodiments of this application, after step 601, the information reporting method provided in this embodiment of this application further includes the following step 701, step 702, step 703, or step 704.

Step 701: If the first network side device is a network side device corresponding to a first cell, the first network side device directly optimizes the first configuration based on the first information.

The first cell is a target cell to which the UE executes CHO.

In some embodiments of this application, the foregoing step 701 may be implemented by the following step 701a.

Step 701a: If the first network side device is the network side device corresponding to the first cell, the first network side device performs at least one of the following:
the first network side device directly optimizes a CHO configuration;
the first network side device forwards CPA-related information to a network side device corresponding to a CPA candidate cell; and
the first network side device forwards CPC-related information to a network side device corresponding to a CPC candidate cell.

It may be understood that the first network side device directly optimizes the CHO configuration based on CHO-related information in the first information; forwards the CPA-related information to the network side device corresponding to the CPA candidate cell, so that the network side device corresponding to the CPA candidate cell optimizes a CPA configuration based on the CPA-related information; and forwards the CPC-related information to the network side device corresponding to the CPC candidate cell, so that the network side device corresponding to the CPC candidate cell optimizes a CPC configuration based on the CPC-related information.

In this embodiment of this application, the first network side device may directly optimize the CHO configuration based on CHO-related information in the first information, forward the CPA-related information in the first information to the network side device corresponding to the CPA candidate cell, and forward the CPC-related information in the first information to the network side device corresponding to the CPC candidate cell, so that the network side device corresponding to the CPA candidate cell can optimize a CPA configuration based on the CPA-related information, and the network side device corresponding to the CPC candidate cell can optimize a CPC configuration based on the CPC-related information.

Step 702: If the first network side device is not the network side device corresponding to the first cell, the first network side device forwards the first information to the third network side device.

In this embodiment of this application, the first information is used by a third network side device to optimize the first configuration.

In this embodiment of this application, the third network side device is a network side device corresponding to the first cell.

In some embodiments of this application, the third network side device performs at least one of the following:
the third network side device directly optimizes a CHO configuration;
the third network side device forwards CPA-related information to a network side device corresponding to a CPA candidate cell; and
the third network side device forwards CPC-related information to a network side device corresponding to a CPC candidate cell.

It may be understood that the third network side device directly optimizes the CHO configuration based on CHO-related information in the first information; forwards the CPA-related information to the network side device corresponding to the CPA candidate cell, so that the network side device corresponding to the CPA candidate cell optimizes a CPA configuration based on the CPA-related information; and forwards the CPC-related information to the network side device corresponding to the CPC candidate cell, so that the network side device corresponding to the CPC candidate cell optimizes a CPC configuration based on the CPC-related information.

In this embodiment of this application, the first network side device may forward the first information to the third network side device, and then the third network side device directly optimizes the CHO configuration based on the CHO-related information in the first information, forwards the CPA-related information in the first information to the network side device corresponding to the CPA candidate cell, and forwards the CPC-related information in the first information to the network side device corresponding to the CPC candidate cell, so that the network side device corresponding to the CPA candidate cell can optimize a CPA configuration based on the CPA-related information, and the network side device corresponding to the CPC candidate cell can optimize a CPC configuration based on the CPC-related information.

Step 703: If the first network side device is not the network side device corresponding to the first cell, the first network side device performs at least one of the following: forwarding CHO-related information in the first information to a third network side device, forwarding CPA-related information in the first information to a network side device corresponding to a CPA candidate cell, and forwarding CPC-related information in the first information to a network side device corresponding to a CPC candidate cell.

It may be understood that the first network side device forwards the CHO-related information in the first information to the third network side device, so that the third network side device directly optimizes the CHO configuration based on the CHO-related information in the first information; forwards the CPA-related information in the first information to the network side device corresponding to the CPA candidate cell, so that the network side device corresponding to the CPA candidate cell optimizes the CPA configuration based on the CPA-related information; and forwards the CPC-related information in the first information to the network side device corresponding to the CPC candidate cell, so that the network side device corresponding to the CPC candidate cell optimizes the CPC configuration based on the CPC-related information.

In this embodiment of this application, the first network side device may forward the CHO-related information in the first information to the third network side device, forward the CPA-related information in the first information to the network side device corresponding to the CPA candidate cell, and forward the CPC-related information in the first information to the network side device corresponding to the CPC candidate cell, so that the third network side device can directly optimize the CHO configuration based on the CHO-related information in the first information, the network side device corresponding to the CPA candidate cell can optimize the CPA configuration based on the CPA-related information, and the network side device corresponding to the CPC candidate cell can optimize the CPC configuration based on the CPC-related information.

Step 704: If the first network side device is a network side device corresponding to a sixth cell, the first network side device forwards the first information to a network side device corresponding to a CHO candidate cell.

In this embodiment of this application, the sixth cell is a primary cell connected to the UE when third information is generated, the first information includes the third information, and the third information is used to indicate a radio link problem of the SCG in a case that the UE has not executed CHO.

It may be understood that in a case that the UE fails to execute CHO, the UE may report the first information to the network side device corresponding to the sixth cell, that is, a network side device corresponding to the primary cell connected to the UE. Then, the network side device corresponding to the primary cell connected to the UE may forward the first information to the network side device corresponding to the CHO candidate cell, so that the network side device corresponding to the CHO candidate cell optimizes the CHO configuration.

In this embodiment of this application, the first network side device reports the first information to the network side device corresponding to the primary cell connected to the UE, so that the network side device corresponding to the primary cell connected to the UE can forward the first information to the network side device corresponding to the CHO candidate cell, and the network side device corresponding to the CHO candidate cell can optimize the CHO configuration.

In some embodiments of this application, the information reporting method provided in this embodiment of this application further includes the following step 801.

Step 801: If the first network side device is not the network side device corresponding to the first cell, the first network side device performs at least one of the following:
the first network side device forwards the CPA-related information to the network side device corresponding to the CPA candidate cell by using the third network side device; and
the first network side device forwards the CPC-related information to the network side device corresponding to the CPC candidate cell by using the third network side device.

It may be understood that in a case that the first network side device is not the network side device corresponding to the first cell, the first network side device may directly forward the CPA-related information in the first information to the network side device corresponding to the CPA candidate cell, and forward the CPC-related information to the network side device corresponding to the CPC candidate cell; or may forward the entire first information to the third network side device, and then the third network side device forwards the CPA-related information to the network side device corresponding to the CPA candidate cell, and forwards the CPC-related information to the network side device corresponding to the CPC candidate cell.

In some embodiments of this application, the first information includes any one of the following: second information, third information, and fourth information.

It should be noted that for related descriptions of the second information, the third information, and the fourth information, reference may be made to the descriptions in the foregoing embodiment. Details are not described herein again.

The information reporting method provided in the embodiments of this application may be performed by an information reporting apparatus. In the embodiments of this application, that the information reporting apparatus performs the information reporting method is used as an example to describe the information reporting apparatus provided in the embodiments of this application.

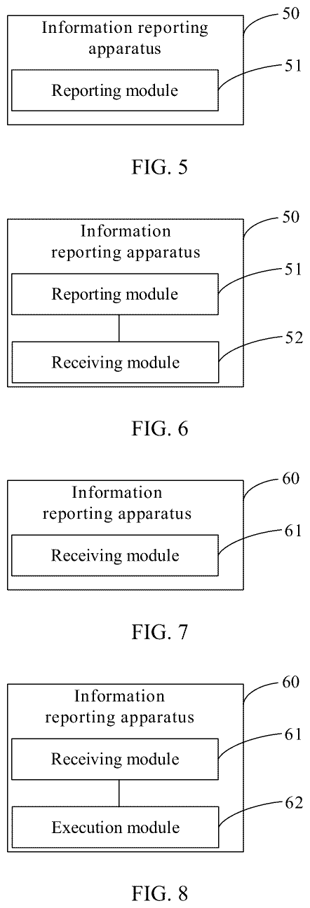

FIG. 5 is a schematic diagram of a structure of an information reporting apparatus according to an embodiment of this application. As shown in FIG. 5, an information reporting apparatus 50 may include a reporting module 51.

The reporting module 51 is configured to report first information to a first network side device. The first information is used to indicate at least one of the following: a radio link problem of an MCG in a first process, and a radio link problem of an SCG in the first process. The first process includes at least one of the following: CHO with CPA, CHO with CPC, CHO with primary secondary cell addition, and CHO with primary secondary cell change.

This embodiment of this application provides an information reporting apparatus, and the information reporting apparatus may report first information to a first network side device. The first information is used to indicate at least one of the following: a radio link problem of an MCG in a first process, and a radio link problem of an SCG in the first process. The first process includes at least one of the following: CHO with CPA, CHO with CPC, CHO with primary secondary cell addition, and CHO with primary secondary cell change. Therefore, the first network side device can learn a problem in a process in which UE performs the first process, thereby learning a reason of a connection failure.

In some implementations, with reference to FIG. 5, as shown in FIG. 6, the information reporting apparatus 50 may further include a receiving module 52. The receiving module 52 is configured to: before UE reports the first information to the first network side device, receive a first configuration sent by a second network side device, where the first configuration is used to configure the UE to perform the first process.

In some implementations, the first configuration includes at least one of the following:
a CHO configuration, where the CHO configuration includes a configuration of at least one CHO candidate cell, a configuration of one CHO candidate cell includes information about one CHO candidate cell and one first trigger condition, the first trigger condition is used by the UE to execute CHO, one first trigger condition corresponds to one CHO candidate cell, and the first trigger condition includes one or two events;
at least one first CPA configuration, where one first CPA configuration includes a configuration of at least one CPA candidate cell, a configuration of one CPA candidate cell includes information about one CPA candidate cell and a second trigger condition, the second trigger condition is used by the UE to execute CPA, one second trigger condition corresponds to one CPA candidate cell, and the second trigger condition includes one or two events;
at least one first CPC configuration, where one first CPC configuration includes a configuration of at least one CPC candidate cell, a configuration of one CPC candidate cell includes information about one CPC candidate cell and a third trigger condition, the third trigger condition is used by the UE to execute CPC, the third trigger condition corresponds to one CPC candidate cell, and the third trigger condition includes one or two events;
a configuration of primary secondary cell addition; and
a configuration of primary secondary cell change; where
one first CPA configuration is associated with a configuration of one CHO candidate cell, one first CPC configuration is associated with a configuration of one CHO candidate cell, the configuration of primary secondary cell addition is associated with a configuration of one CHO candidate cell, and the configuration of primary secondary cell change is associated with a configuration of one CHO candidate cell.

In some implementations, the reporting module 51 is configured to: report second information to the first network side device in a case that a first condition is satisfied, where the first information includes the second information; the first condition is related to at least one of the following: the UE has not executed the CPA or the CPC, and the UE has executed the CPA or the CPC; and the second information is used to indicate a radio link problem of the SCG in a case that the UE successfully executes the CHO;
report third information to the first network side device in a case that a second condition is satisfied, where the first information includes the third information; the second condition is related to at least one of the following: the UE has executed the CHO, and the UE has not executed the CHO; and the third information is used to indicate a radio link problem of the SCG in a case that the UE has not executed the CHO; and
report fourth information to the first network side device in a case that a third condition is satisfied, where the first information includes the fourth information; the third condition is related to a CHO execution failure of the UE; and the fourth information is used to indicate at least one of the following: a radio link problem of the MCG in a case that the UE has executed the CHO and the CHO fails, and a radio link problem of the SCG in a case that the UE has executed the CHO and the CHO fails.

In some implementations, the first condition includes at least one of the following:
the UE is configured with a first configuration;
the UE is configured to be required to report the second information;
the UE is enabled to report the second information;
no CPA candidate cell satisfies the second trigger condition at first time;
no CPC candidate cell satisfies the third trigger condition at the first time;
the UE has not executed the CPA at the first time;
the UE has not executed the CPC at the first time;
no CPA candidate cell satisfies the second trigger condition before second time;
no CPC candidate cell satisfies the third trigger condition before the second time;
the UE has not executed the CPA at the second time;
the UE has not executed the CPC at the second time;
a first time interval exceeds a first threshold;
no CPA candidate cell satisfies the second trigger condition before the first time, and the second trigger condition for CPA is satisfied at third time;
the UE has not executed the CPA at the first time, and the UE has executed the CPA at the third time;
no CPA candidate cell satisfies the second trigger condition before the second time, and the second trigger condition for CPA is satisfied at the third time;
the UE has not executed the CPA at the second time, and the UE has executed the CPA at the third time;
no CPC candidate cell satisfies the third trigger condition before the first time, and the third trigger condition for CPC is satisfied at the third time;
the UE has not executed the CPC at the first time, and the UE has executed the CPC at the third time;
no CPC candidate cell satisfies the third trigger condition before the second time, and the third trigger condition for CPC is satisfied at the third time; and
the UE has not executed the CPC at the second time, and the UE has executed the CPC at the third time; where
the third time is time after the second time, and the second time is time after the first time.

In some implementations, the second information includes at least one of the following:
first indication information, where the first indication information is used to indicate at least one of the following: no CPA candidate cell satisfies the second trigger condition at first time, and the UE has not executed the CPA at the first time;
second indication information, where the second indication information is used to indicate at least one of the following: no CPC candidate cell satisfies the third trigger condition at the first time, and the UE has not executed the CPC at the first time;
third indication information, where the third indication information is used to indicate at least one of the following: no CPA candidate cell satisfies the second trigger condition at second time, and the UE has not executed the CPA at the second time;
fourth indication information, where the fourth indication information is used to indicate at least one of the following: no CPC candidate cell satisfies the third trigger condition at the second time, and the UE has not executed the CPC at the second time;
a first time interval;
a second time interval;
fifth indication information, where the fifth indication information is used to indicate that a source SCG fails or does not fail when the UE executes the CHO to a first cell;
sixth indication information, where the sixth indication information is used to indicate that a first timer used for the SCG when the UE executes the CHO to the first cell is running or has not been started;
seventh indication information, where the seventh indication information is used to indicate a running status of the first timer used for the SCG when the UE executes the CHO to the first cell;
a measurement result of a second cell at the first time;
a measurement result of the second cell at the second time;
at least one piece of eighth indication information, where each piece of eighth indication information in the at least one piece of eighth indication information is used to indicate that the second cell is a CPA candidate cell or is not a CPA candidate cell;
at least one piece of ninth indication information, where each piece of ninth indication information in the at least one piece of ninth indication information is used to indicate that the second cell is a CPC candidate cell or is not a CPC candidate cell;
a satisfaction status of the second trigger condition for each CPA candidate cell at the first time;
a satisfaction status of the third trigger condition for each CPC candidate cell at the first time;
the second trigger condition for each CPA candidate cell;
the third trigger condition for each CPC candidate cell; and
information about the first cell; where
the second cell includes at least one of the following: a neighboring cell of a current serving cell before the UE executes CHO, and a neighboring cell of a current serving cell after the UE executes CHO; and the measurement result includes at least one of the following: reference signal received power RSRP, reference signal received quality RSRQ, and a signal-to-interference-plus-noise ratio SINR.

In some implementations, the first time includes at least one of the following:
time at which the UE executes the CHO to the first cell;
time at which the UE completes execution of the CHO to the first cell; and
time at which a first trigger condition for at least one CHO candidate cell is satisfied, where the at least one CHO candidate cell includes the first cell.

In some implementations, the second time is time represented by the second time interval that is after the first time, where
the first time interval is time elapsed from the first time to fourth time, and the fourth time includes at least one of the following:
time at which the UE executes the CPA to a third cell;
time at which the UE executes the CPC to a fourth cell;
time at which the UE completes execution of the CPA to the third cell;
time at which the UE completes execution of the CPC to the fourth cell;
time at which the second trigger condition for at least CPA candidate cell is satisfied; and
Time when a third trigger condition of a candidate cell of at least one CPC satisfies; where
the third cell is a target cell to which the UE executes the CPA, and the fourth cell is a target cell to which the UE executes the CPC.

In some implementations, the CPA candidate cell is associated with first cell, the CPC candidate cell is associated with the first cell, and the first cell is a target cell to which the UE executes the CHO.

In some implementations, the first timer includes at least one of the following: a T310 timer and a T312 timer.

In some implementations, a satisfaction status of the second trigger condition for the CPA candidate cell includes at least one of the following:
a 1^{st} event in the second trigger condition is satisfied first;
a 2^{nd} event in the second trigger condition is satisfied first;
time elapsed from time at which the 1^{st} event in the second trigger condition is satisfied to time at which the 2^{nd} event is satisfied; and
a difference between a first measurement result and the second trigger condition in a case that the second trigger condition is not satisfied, where the first measurement result includes a measurement result of the CPA candidate cell; and
a satisfaction status of the third trigger condition for the CPC candidate cell includes at least one of the following:
a 1^{st} event in the third trigger condition is satisfied first;
a 2^{nd} event in the third trigger condition is satisfied first;
time elapsed from time at which the 1^{st} event in the third trigger condition is satisfied to time at which the 2^{nd} event is satisfied; and
a difference between a second measurement result and the third trigger condition in a case that the third trigger condition not satisfied, where the second measurement result includes at least one of the following: a measurement result of a source primary secondary cell, and a measurement result of the CPC candidate cell.

In some implementations, the information about the first cell includes at least one of the following:
a physical cell identifier ID;
a cell ID;
a cell global identity CGI;
a 1^{st} network identifier broadcast in the first cell; and
an identifier of a tracking area to which the first cell belongs, where the identifier of the tracking area is associated with the 1^{st} network identifier broadcast in the first cell.

In some implementations, the second information further includes at least one of the following:
second information obtained most recently before the first time;
second information obtained most recently before the second time; and
second information obtained most recently before third time.

In some implementations, the reporting module 51 is configured to perform any one of the following:
in a case that the first condition is satisfied, the UE carries the second information by using a CHO handover complete message;
in a case that the first condition is satisfied, the UE triggers a process of reporting SCG failure information, and carries the second information by using the SCG failure information; and
in a case that the first condition is satisfied, the UE stores the second information into a first variable, and carries the second information by using a first message based on an instruction of the first network side device.

In some implementations, the reporting module 51 is configured to: store the second information into the first variable; send tenth indication information to the first network side device, where the tenth indication information is used to indicate that there is available second information in the first variable; and send a first message to the first network side device in a case that eleventh indication information sent by the first network side is received, where the second information is carried by using the first message, and the eleventh indication information is used to instruct the UE to report the second information.

In some implementations, the second condition includes at least one of the following:
the UE is configured with a first configuration;
the UE is configured to be required to report the third information;
the UE is enabled to report the third information;
at least one CPA candidate cell satisfies the second trigger condition, a fifth cell does not satisfy the first trigger condition, the CPA candidate cell is associated with the fifth cell, and the fifth cell is one of CHO candidate cells;
at least one CPC candidate cell satisfies the third trigger condition, a sixth cell does not satisfy the first trigger condition, the CPC candidate cell is associated with the sixth cell, and the sixth cell is one of CHO candidate cells;
the SCG fails;
a first timer used for the SCG has been started;
running duration of the first timer used for the SCG exceeds a second threshold;
the MCG fails;
a second timer for the MCG has been started; and
running duration of the second timer used for the MCG exceeds a third threshold.

In some implementations, the second timer includes at least one of the following: a T310 timer and a T312 timer.

In some implementations, the third information includes at least one of the following:
information about at least one seventh cell, where one seventh cell is a CPA candidate cell, and one seventh cell satisfies the second trigger condition;
information about at least one eighth cell, where one eighth cell is a CPC candidate cell, and one eighth cell satisfies the third trigger condition;
a satisfaction status of a first trigger condition for a fifth cell, where the fifth cell is a CHO candidate cell, and the fifth cell is associated with all seventh cells;
a satisfaction status of a first trigger condition for a sixth cell, where the sixth cell is a CHO candidate cell, and the sixth cell is associated with all eighth cells;
the first trigger condition for the fifth cell;
the first trigger condition for the sixth cell;
a measurement result of the fifth cell, where the measurement result includes at least one of the following: RSRP, RSRQ, and a SINR;
a measurement result of the sixth cell, where the measurement result includes at least one of the following: RSRP, RSRQ, and a SINR;
a measurement result of a neighboring cell of a current serving cell; and
information about a ninth cell, where the ninth cell is a primary cell connected to the UE when the third information is generated.

In some implementations, the third information further includes at least one of the following:
third information obtained most recently before the SCG fails;
third information obtained when the at least one CPA candidate cell satisfies the second trigger condition; and
third information obtained when the at least one CPC candidate cell satisfies the third trigger condition.

In some implementations, information about one seventh cell includes at least one of the following:
a physical cell ID;
a cell ID;
a CGI;
a 1^{st} network identifier broadcast in one seventh cell; and
an identifier of a tracking area to which one seventh cell belongs, where the identifier of the tracking area is associated with the 1^{st} network identifier broadcast in one seventh cell; and
information about one eighth cell includes at least one of the following:
a physical cell ID;
a cell ID;
a CGI;
a 1^{st} network identifier broadcast in one eighth cell; and
an identifier of a tracking area to which one eighth cell belongs, where the identifier of the tracking area is associated with the 1^{st} network identifier broadcast in one eighth cell.

In some implementations, a satisfaction status of a first trigger condition for the fifth cell includes at least one of the following:
a 1^{st} event in the first trigger condition is satisfied first;
a 2^{nd} event in the first trigger condition is satisfied first;
time elapsed from time at which the 1^{st} event in the first trigger condition is satisfied to time at which the 2^{nd} event is satisfied; and
a difference between a third measurement result and the first trigger condition in a case that the first trigger condition is not satisfied, where the third measurement result includes at least one of the following: a measurement result of the fifth cell, and a measurement result of a primary cell; and
a satisfaction status of a first trigger condition for the sixth cell includes at least one of the following:
a 1^{st} event in the first trigger condition is satisfied first;
a 2^{nd} event in the first trigger condition is satisfied first;
time elapsed from time at which the 1^{st} event in the first trigger condition is satisfied to time at which the 2^{nd} event is satisfied; and
a difference between a fourth measurement result and the first trigger condition in a case that the first trigger condition is not satisfied, where the fourth measurement result includes at least one of the following: a measurement result of the sixth cell, and a measurement result of a primary cell.

In some implementations, the measurement result of the neighboring cell includes at least one of the following:
a signal measurement result of the neighboring cell, where the signal measurement result includes at least one of the following: RSRP, RSRQ, and a SINR;
twelfth indication information, where the twelfth indication information is used to indicate whether the neighboring cell is a CHO candidate cell;
thirteenth indication information, where the thirteenth indication information is used to indicate whether the neighboring cell is a CPA candidate cell;
fourteenth indication information, where fourteenth indication information is used to indicate whether the neighboring cell is a CPC candidate cell;
fifteenth indication information, where in a case that the neighboring cell is a CHO candidate cell, the fifteenth indication information is used to indicate whether the neighboring cell satisfies the first trigger condition; in a case that the neighboring cell is a CPA candidate cell, the fifteenth indication information is used to indicate whether the neighboring cell satisfies the second trigger condition; and in a case that the neighboring cell is a CPC candidate cell, the fifteenth indication information is used to indicate whether the neighboring cell satisfies the third trigger condition;
a first association relationship, where the first association relationship is used to indicate an association relationship between the CHO candidate cell and the CPA candidate cell; and
a second association relationship, where the second association relationship is used to indicate an association relationship between the CHO candidate cell and the CPC candidate cell.

In some implementations, the information about the ninth cell includes at least one of the following:
cell identity related information of the ninth cell, where the cell identity related information includes at least one of the following: a physical cell ID, a cell ID, a CGI, a 1^{st} network identity broadcast in the ninth cell, and an identifier of a tracking area to which the ninth cell belongs, where the identifier of the tracking area is associated with the 1^{st} network identity broadcast in the ninth cell; and
link status related information, where the link status related information includes at least one of the following:
sixteenth indication information, where the sixteenth indication information is used to indicate that a second timer used for the MCG is running or has not been started;
seventeenth indication information, where the seventeenth indication information is used to indicate a running status of the second timer used for the MCG; and
eighteenth indication information, where the eighteenth indication information is used to indicate whether a radio link failure occurs in the ninth cell.

In some implementations, the reporting module 51 is configured to perform either of the following:
in a case that the second condition is satisfied, the UE triggers a process of reporting SCG failure information, and carries the third information by using the SCG failure information; and
in a case that the second condition is satisfied, the UE stores the third information into a second variable, and carries the third information by using a second message based on an instruction of the first network side device

In some implementations, the reporting module 51 is configured to: store the third information into the second variable; send nineteenth indication information to the first network side device, where the nineteenth indication information is used to indicate that there is available third information in the second variable; and send a second message to the first network side device in a case that twentieth indication information sent by the first network side device, where the third information is carried by using the second message, and the twentieth indication information is used to instruct the UE to report the third information

In some implementations, the third condition includes at least one of the following:
the UE is configured with a first configuration;
the UE is configured to be required to report the fourth information;
the UE is enabled to report the fourth information; and
the MCG fails.

In some implementations, the fourth information includes at least one of the following:
information about at least one tenth cell, where one tenth cell is a CPA candidate cell, and one tenth cell satisfies the second trigger condition;
information about at least one eleventh cell, where one eleventh cell is a CPC candidate cell, and one eleventh cell satisfies the third trigger condition;
a measurement result of a neighboring cell of a current serving cell;
related information of a source SCG link status when the UE executes the CHO to a first cell, where the first cell is a target cell to which the UE executes the CHO;
twenty-first indication information, where the twenty-first indication information is used to indicate whether the UE has executed the CPA;
twenty-second indication information, where the twenty-second indication information is used to indicate whether the CPA succeeds;
twenty-third indication information, where the twenty-third indication information is used to indicate whether the UE has executed the CPC;
twenty-fourth indication information, where the twenty-fourth indication information is used to indicate whether the CPC succeeds;
twenty-fifth indication information, where the twenty-fifth indication information is used to indicate whether the UE has executed primary secondary cell addition;
twenty-sixth indication information, where the twenty-sixth indication information is used to indicate whether the UE has executed primary secondary cell change;
twenty-seventh indication information, where the twenty-seventh indication information is used to indicate whether the primary secondary cell addition succeeds;
twenty-eighth indication information, where the twenty-eighth indication information is used to indicate whether the primary secondary cell change succeeds;
a satisfaction status of the second trigger condition for the CPA candidate cell when the fourth information is generated; and
a satisfaction status of the third trigger condition for the CPC candidate cell when the fourth information is generated; where
the CPA candidate cell is associated with the first cell, and the CPC candidate cell is associated with the first cell.

In some implementations, the fourth information further includes at least one of the following:
fourth information obtained during a most recent MCG failure;
fourth information obtained during a CHO failure; and
fourth information obtained during each of two CHO failures.

In some implementations, information about one tenth includes at least one of the following:
a physical cell ID;
a cell ID;
a CGI;
a 1^{st} network identifier broadcast in one tenth cell; and
an identifier of a tracking area to which one tenth cell belongs, where the identifier of the tracking area is associated with the 1^{st} network identifier broadcast in one tenth cell; and
information about one eleventh cell includes at least one of the following:
a physical cell ID;
a cell ID;
a CGI;
a 1^{st} network identifier broadcast in one eleventh cell; and
an identifier of a tracking area to which one eleventh cell belongs, where the identifier of the tracking area is associated with the 1^{st} network identifier broadcast in one eleventh cell.

In some implementations, the related information of the source SCG link status when the UE is indicated to execute the CHO to the first cell includes at least one of the following:
information indicating that a source SCG fails or does not fail when the UE executes the CHO to the first cell;
information indicating that a first timer used for the SCG is running or has not been started when the UE executes the CHO to the first cell; and
information indicating a running status of the first timer used for the SCG when the UE executes the CHO to the first cell; where
the first timer includes at least one of the following: a T310 timer and a T312 timer.

In some implementations, the reporting module 51 is configured to perform either of the following:
sending a radio link failure RLF report to the first network side device, where the RLF report includes the fourth information; and
sending an information response message to the first network side device, where a first domain of the information response message includes the fourth information.

FIG. 7 is a schematic diagram of a structure of an information reporting apparatus according to an embodiment of this application. As shown in FIG. 7, an information reporting apparatus 60 may include a receiving module 61.

The receiving module 61 is configured to receive first information from UE. The first information is used to indicate at least one of the following: a radio link problem of an MCG in a first process, and a radio link problem of an SCG in the first process. The first process includes at least one of the following: CHO with CPA, CHO with CPC, CHO with primary secondary cell addition, and CHO with primary secondary cell change.

This embodiment of this application provides an information reporting apparatus, and the information reporting apparatus may receive first information from UE. The first information is used to indicate at least one of the following: a radio link problem of an MCG in a first process, and a radio link problem of an SCG in the first process. The first process includes at least one of the following: CHO with CPA, CHO with CPC, CHO with primary secondary cell addition, and CHO with primary secondary cell change. Therefore, a first network side device can learn a problem in a process in which the UE performs the first process, thereby learning a reason of a connection failure.

In some implementations, the first information is used to optimize a first configuration, and the first configuration is used to configure the UE to perform the first process.

In some implementations, with reference to FIG. 7, as shown in FIG. 8, the information reporting apparatus 60 may include an execution module 62. The execution module 62 is configured to: after the first network side device receives the first information from the UE, perform any one of the following:
if the first network side device is a network side device corresponding to a first cell, the first network side device directly optimizes the first configuration based on the first information;
if the first network side device is not the network side device corresponding to the first cell, the first network side device forwards the first information to a third network side device, where the first information is used by the third network side device to optimize the first configuration;
if the first network side device is not the network side device corresponding to the first cell, the first network side device performs at least one of the following: forwarding CHO-related information in the first information to the third network side device, forwarding CPA-related information in the first information to a network side device corresponding to a CPA candidate cell, and forwarding CPC-related information in the first information to a network side device corresponding to a CPC candidate cell; and
if the first network side device is a network side device corresponding to a sixth cell, the first network side device forwards the first information to a network side device corresponding to a CHO candidate cell; where
the first cell is a target cell to which the UE executes CHO, the third network side device is the network side device corresponding to the first cell, the sixth cell is a primary cell connected to the UE when third information is generated, the first information includes the third information, and the third information is used to indicate a radio link problem of an SCG in a case that the UE has not executed the CHO.

In some implementations, the execution module 62 is configured to perform at least one of the following:
the first network side device directly optimizes a CHO configuration;
the first network side device forwards CPA-related information to a network side device corresponding to a CPA candidate cell; and
the first network side device forwards CPC-related information to a network side device corresponding to a CPC candidate cell.

In some implementations, if the first network side device is not the network side device corresponding to the first cell, the execution module 62 is further configured to perform at least one of the following:
the first network side device forwards the CPA-related information to the network side device corresponding to the CPA candidate cell by using the third network side device;
and the first network side device forwards the CPC-related information to the network side device corresponding to the CPC candidate cell by using the third network side device.

In some implementations, the first information includes any one of the following: second information, third information, and fourth information.

The information reporting apparatus in this embodiment of this application may be an electronic device, for example, an electronic device with an operating system, or may be a component in the electronic device, for example, an integrated circuit or a chip. The apparatus may be a mobile electronic device, or may be a non-mobile electronic device. For example, the mobile electronic device may be a mobile phone, a tablet computer, a notebook computer, a palmtop computer, a vehicle-mounted electronic device, a wearable device, a UMPC, a netbook, a PDA, or the like. The non-mobile electronic device may be a server, a Network Attached Storage (NAS), a personal computer, a television, a counter, or a self-service computer. This is not limited in this embodiment of this application.

The information reporting apparatus provided in this embodiment of this application can implement the processes implemented in the foregoing method embodiments, and achieve a same technical effect. To avoid repetition, details are not described herein again.

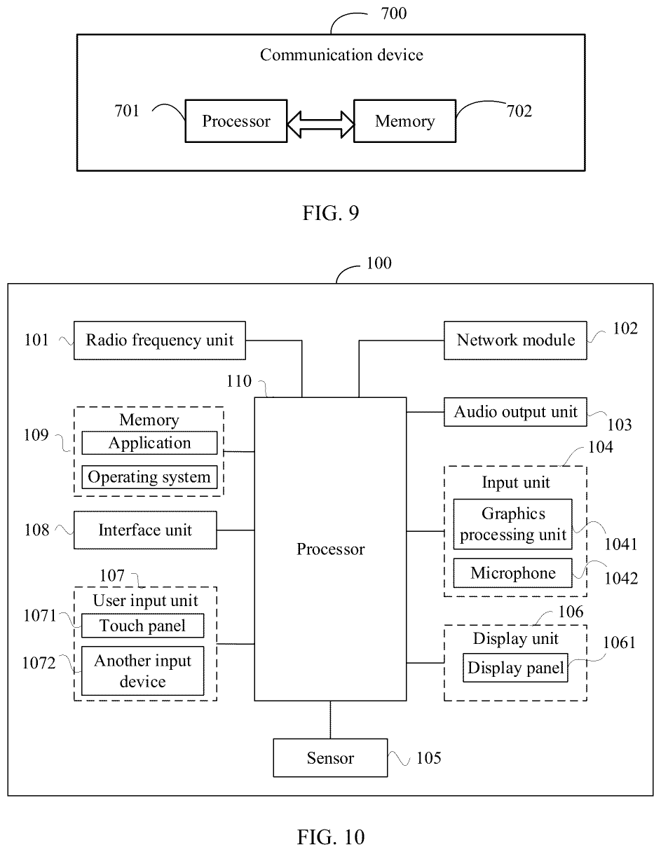

In some implementations, as shown in FIG. 9, an embodiment of this application further provides a communication device 700, including a processor 701 and a memory 702, and the memory 702 stores a program or instructions capable of being run on the processor 701. For example, in a case that the communication device 700 is UE, when the program or the instructions are executed by the processor 701, the steps of the foregoing embodiments are implemented, and a same technical effect can be achieved. In a case that the communication device 700 is a first network side device, when the program or the instructions are executed by the processor 701, the steps of the foregoing embodiments are implemented, and a same technical effect can be achieved. To avoid repetition, details are not described herein again.

An embodiment of this application further provides UE, including a processor and a communication interface. The communication interface is coupled to the processor, and the processor is configured to run a program or instructions, to implement steps of the foregoing method embodiments. This UE embodiment is corresponding to the foregoing method embodiment on the UE side. Each implementation process and implementation of the foregoing method embodiment may be applicable to this UE embodiment, and a same technical effect can be achieved. In some implementations, FIG. 10 is a schematic diagram of a hardware structure of UE according to an embodiment of this application.

UE 100 includes but is not limited to at least a part of components such as a radio frequency unit 101, a network module 102, an audio output unit 103, an input unit 104, a sensor 105, a display unit 106, a user input unit 107, an interface unit 108, a memory 109, and a processor 110.

A person skilled in the art can understand that the UE 100 may further include a power supply (such as a battery) that supplies power to each component. The power supply may be logically connected to the processor 110 by using a power supply management system, to implement functions such as charging and discharging management, and power consumption management by using the power supply management system. A UE structure shown in FIG. 10 constitutes no limitation on the UE, and the UE may include more or fewer components than those shown in the figure, or combine some components, or have different component arrangements. Details are not described herein.

It should be understood that in this embodiment of this application, the input unit 104 may include a Graphics Processing Unit (GPU) 1041 and a microphone 1042. The graphics processing unit 1041 processes image data of a static picture or a video obtained by an image capture apparatus (for example, a camera) in a video capture mode or an image capture mode. The display unit 106 may include a display panel 1061, and the display panel 1061 may be configured in a form of a liquid crystal display, an organic light-emitting diode, or the like. The user input unit 107 includes at least one of a touch panel 1071 and another input device 1072. The touch panel 1071 is also referred to as a touchscreen. The touch panel 1071 may include two parts: a touch detection apparatus and a touch controller. The another input device 1072 may include but is not limited to a physical keyboard, a functional button (for example, a volume control button or a power on/off button), a trackball, a mouse, and a joystick. Details are not described herein.

In this embodiment of this application, after receiving downlink data from a network side device, the radio frequency unit 101 may transmit the downlink data to the processor 110 for processing. In addition, the radio frequency unit 101 may send uplink data to the network side device. Generally, the radio frequency unit 101 includes but is not limited to an antenna, an amplifier, a transceiver, a coupler, a low noise amplifier, a duplexer, and the like.

The memory 109 may be configured to store a software program or an instruction and various data. The memory 109 may mainly include a first storage area for storing a program or an instruction and a second storage area for storing data. The first storage area may store an operating system, and an application or an instruction required by at least one function (for example, a sound playing function or an image playing function). In addition, the memory 109 may include a volatile memory or a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 109 in this embodiment of this application includes but is not limited to these memories and any memory of another proper type.

The processor 110 may include one or more processing units. In some implementations, an application processor and a modem processor are integrated into the processor 110. The application processor mainly processes an operating system, a user interface, an application, or the like. The modem processor mainly processes a wireless communication signal, for example, a baseband processor. It may be understood that, in some implementations, the modem processor may not be integrated into the processor 110.

The radio frequency unit 101 is configured to report first information to a first network side device. The first information is used to indicate at least one of the following: a radio link problem of an MCG in a first process, and a radio link problem of an SCG in the first process.

The first process includes at least one of the following:
conditional handover CHO with conditional primary secondary cell addition CPA;
CHO with conditional primary secondary cell change CPC;
CHO with primary secondary cell addition; and
CHO with primary secondary cell change.

This embodiment of this application provides UE, and the UE may report first information to a first network side device. The first information is used to indicate at least one of the following: a radio link problem of an MCG in a first process, and a radio link problem of an SCG in the first process. The first process includes at least one of the following: CHO with CPA, CHO with CPC, CHO with primary secondary cell addition, and CHO with primary secondary cell change. Therefore, the first network side device can learn a problem in a process in which the UE performs the first process, thereby learning a reason of a connection failure.

It may be understood that, for an implementation process of the implementations mentioned in this embodiment, reference may be made to related descriptions of the method embodiments, and a same or corresponding technical effect is achieved. To avoid repetition, details are not described herein again.

An embodiment of this application further provides a first network side device, including a processor and a communication interface. The communication interface is coupled to the processor, and the processor is configured to run a program or instructions to implement the steps of the foregoing method embodiments. This first network side device embodiment is corresponding to the foregoing method embodiment of the first network side device. Each implementation process and implementation of the foregoing method embodiment may be applicable to this first network side device embodiment, and a same technical effect can be achieved.

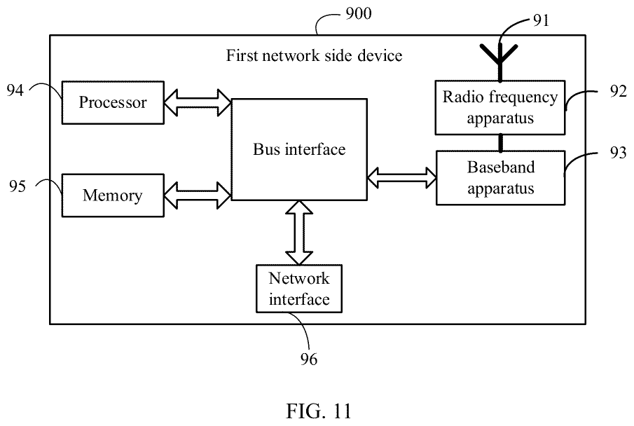

In some implementations, an embodiment of this application further provides a first network side device. As shown in FIG. 11, a first network side device 900 includes an antenna 91, a radio frequency apparatus 92, a baseband apparatus 93, a processor 94, and a memory 95. The antenna 91 is connected to the radio frequency apparatus 92. In an uplink direction, the radio frequency apparatus 92 receives information through the antenna 91, and sends the received information to the baseband apparatus 93 for processing. In a downlink direction, the baseband apparatus 93 processes information that needs to be sent, and sends processed information to the radio frequency apparatus 92. The radio frequency apparatus 92 processes the received information, and sends processed information by using the antenna 91.

In the foregoing embodiment, the method performed by the first network side device may be implemented in the baseband apparatus 93. The baseband apparatus 93 includes a baseband processor.

For example, the baseband apparatus 93 may include at least one baseband board. A plurality of chips are disposed on the baseband board. As shown in FIG. 9, one chip is, for example, a baseband processor, and is connected to the memory 95 by using a bus interface, to invoke a program in the memory 95 to execute the operations of the network device shown in the foregoing method embodiment.

The first network side device may further include a network interface 96, and the interface is, for example, a common public radio interface (common public radio interface, CPRI).

In some implementations, the first network side device 900 in this embodiment of the present disclosure further includes instructions or a program stored in the memory 95 and capable of being run on the processor 94, and the processor 94 invokes the instructions or the program in the memory 95 to perform the method performed by the modules shown in FIG. 11, and a same technical effect is achieved. To avoid repetition, details are not described herein again.

The radio frequency apparatus 92 is configured to receive first information from the UE. The first information is used to indicate at least one of the following: a radio link problem of an MCG in a first process, and a radio link problem of an SCG in the first process.

The first process includes at least one of the following:
CHO with CPA;
CHO with CPC;
CHO with primary secondary cell addition; and
CHO with primary secondary cell change.

This embodiment of this application provides a first network side device, and the first network side device may receive first information from UE. The first information is used to indicate at least one of the following: a radio link problem of an MCG in a first process, and a radio link problem of an SCG in the first process; and the first process includes at least one of the following: CHO with CPA, CHO with CPC, CHO with primary secondary cell addition, and CHO with primary secondary cell change. Therefore, the first network side device can learn a problem in a process in which the UE performs the first process, thereby learning a reason of a connection failure.

An embodiment of this application further provides a readable storage medium. The readable storage medium stores a program or instructions, and when the program or the instructions are executed by a processor, the processes of the foregoing embodiment of the information indication method are performed, and a same technical effect can be achieved. To avoid repetition, details are not described herein again.

The processor is a processor in the UE in the foregoing embodiments. The readable storage medium includes a computer-readable storage medium, such as a computer ROM, a RAM, a magnetic disk, or an optical disc. In some examples, the readable storage medium may be a non-transient readable storage medium.

An embodiment of this application further provides a chip. The chip includes a processor and a communication interface, the communication interface is coupled to the processor, and the processor is configured to run a program or instructions to implement the processes of the foregoing method embodiment, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a non-volatile storage medium, and the computer program/program product is executed by at least one processor to implement the processes of the foregoing method embodiment, and a same technical effect can be achieved. To avoid repetition, details are not described herein again.

An embodiment of this application further provides a wireless communication system, including UE and a first network side device. The UE may be configured to perform the steps of the foregoing information reporting method, and the first network side device may be configured to perform the steps of the foregoing information reporting method.

It should be noted that, in this specification, the terms “include,” “comprise,” or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by a computer software product in addition to a necessary universal hardware platform or certainly by hardware. The computer software product is stored in a storage medium (such as a ROM, a RAM, a magnetic disk, or an optical disc), and includes several instructions for instructing UE or a first network side device to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms of implementations without departing from the purpose of this application and the protection scope of the claims, all of which fall within the protection of this application.

1. An information transmission method, performed by User Equipment (UE), comprising:
reporting first information to a first network side device; wherein
the first information is used to indicate at least one of the following: a radio link problem of a Master Cell Group (MCG) in a first process, or a radio link problem of a Secondary Cell Group (SCG) in the first process; and
the first process comprises at least one of the following:
Conditional HandOver (CHO) with Conditional Primary secondary cell Addition (CPA);
CHO with Conditional Primary secondary cell Change (CPC);
CHO with primary secondary cell addition; or
CHO with primary secondary cell change.

2. The method according to claim 1, wherein before the reporting first information to a first network side device, the method further comprises:
receiving a first configuration sent by a second network side device, wherein the first configuration is used to configure the UE to perform the first process.

3. The method according to claim 2, wherein the first configuration comprises at least one of the following:
a CHO configuration, wherein the CHO configuration comprises a configuration of at least one CHO candidate cell, a configuration of one CHO candidate cell comprises information of at least one CHO candidate cell and one first trigger condition, the first trigger condition is used by the UE to execute CHO, each first trigger condition corresponds to one CHO candidate cell, and the first trigger condition comprises one or two events;
at least one first CPA configuration, wherein each first CPA configuration comprises a configuration of at least one CPA candidate cell, a configuration of one CPA candidate cell comprises information of at least one CPA candidate cell and a second trigger condition, the second trigger condition is used by the UE to execute CPA, each second trigger condition corresponds to one CPA candidate cell, and the second trigger condition comprises one or two events;
at least one first CPC configuration, wherein each first CPC configuration comprises a configuration of at least one CPC candidate cell, a configuration of one CPC candidate cell comprises information of one CPC candidate cell and a third trigger condition, the third trigger condition is used by the UE to execute CPC, each third trigger condition corresponds to one CPC candidate cell, and the third trigger condition comprises one or two events;
a configuration of primary secondary cell addition; or
a configuration of primary secondary cell change, wherein
one first CPA configuration is associated with a configuration of one CHO candidate cell, one first CPC configuration is associated with a configuration of one CHO candidate cell, the configuration of primary secondary cell addition is associated with a configuration of one CHO candidate cell, and the configuration of primary secondary cell change is associated with a configuration of one CHO candidate cell.

4. The method according to claim 3, wherein the reporting first information to a first network side device comprises at least one of the following:
reporting second information to the first network side device when a first condition is satisfied, wherein:
the first information comprises the second information;
the first condition is related to at least one of the following: the UE has not executed the CPA or the CPC, or the UE has executed the CPA or the CPC; and
the second information is used to indicate a radio link problem of the SCG when the UE successfully executes the CHO;
reporting third information to the first network side device when a second condition is satisfied, wherein:
the first information comprises the third information;
the second condition is related to at least one of the following: the UE has executed the CHO, or the UE has not executed the CHO; and
the third information is used to indicate a radio link problem of the SCG when the UE has not executed the CHO; or
reporting fourth information to the first network side device when a third condition is satisfied, wherein:
the first information comprises the fourth information;
the third condition is related to a CHO execution failure of the UE; and
the fourth information is used to indicate at least one of the following: a radio link problem of the MCG when the UE has executed the CHO and the CHO fails, or a radio link problem of the SCG when the UE has executed the CHO and the CHO fails.

5. The method according to claim 4, wherein the first condition comprises at least one of the following:
the UE is configured with a first configuration;
the UE is configured to be required to report the second information;
the UE is enabled to report the second information;
no CPA candidate cell satisfies the second trigger condition at first time;
no CPC candidate cell satisfies the third trigger condition at the first time;
the UE has not executed the CPA at the first time;
the UE has not executed the CPC at the first time;
no CPA candidate cell satisfies the second trigger condition before second time;
no CPC candidate cell satisfies the third trigger condition before the second time;
the UE has not executed the CPA at the second time;
the UE has not executed the CPC at the second time;
a first time interval exceeds a first threshold;
no CPA candidate cell satisfies the second trigger condition before the first time, and the second trigger condition for the CPA is satisfied at third time;
the UE has not executed the CPA at the first time, and the UE has executed the CPA at the third time;
no CPA candidate cell satisfies the second trigger condition before the second time, and the second trigger condition for the CPA is satisfied at the third time;
the UE has not executed the CPA at the second time, and the UE has executed the CPA at the third time;
no CPC candidate cell satisfies the third trigger condition before the first time, and the third trigger condition for the CPC is satisfied at the third time;
the UE has not executed the CPC at the first time, and the UE has executed the CPC at the third time;
no CPC candidate cell satisfies the third trigger condition before the second time, and the third trigger condition for the CPC is satisfied at the third time; or
the UE has not executed the CPC at the second time, and the UE has executed the CPC at the third time, wherein
the third time is time after the second time, and the second time is time after the first time.

6. The method according to claim 4, wherein the second information comprises any one of the following:
first indication information, wherein the first indication information is used to indicate at least one of the following: no CPA candidate cell satisfies the second trigger condition at first time, or the UE has not executed the CPA at the first time;
second indication information, wherein the second indication information is used to indicate at least one of the following: no CPC candidate cell satisfies the third trigger condition at the first time, or the UE has not executed the CPC at the first time;
third indication information, wherein the third indication information is used to indicate at least one of the following: no CPA candidate cell satisfies the second trigger condition at second time, or the UE has not executed the CPA at the second time;
fourth indication information, wherein the fourth indication information is used to indicate at least one of the following: no CPC candidate cell satisfies the third trigger condition at the second time, or the UE has not executed the CPC at the second time;
a first time interval;
a second time interval;
fifth indication information, wherein the fifth indication information is used to indicate that a source SCG fails or does not fail when the UE executes the CHO to a first cell;
sixth indication information, wherein the sixth indication information is used to indicate that a first timer used for the SCG when the UE executes the CHO to the first cell is running or has not been started;
seventh indication information, wherein the seventh indication information is used to indicate a running status of the first timer used for the SCG when the UE executes the CHO to the first cell;
a measurement result of a second cell at the first time;
a measurement result of the second cell at the second time;
at least one piece of eighth indication information, wherein each piece of eighth indication information in the at least one piece of eighth indication information is used to indicate that the second cell is a CPA candidate cell or is not a CPA candidate cell;
at least one piece of ninth indication information, wherein each piece of ninth indication information in the at least one piece of ninth indication information is used to indicate that the second cell is a CPC candidate cell or is not a CPC candidate cell;
a satisfaction status of the second trigger condition for each CPA candidate cell at the first time;
a satisfaction status of the third trigger condition for each CPC candidate cell at the first time;
the second trigger condition for each CPA candidate cell;
the third trigger condition for each CPC candidate cell; or
information about the first cell; wherein:
the second cell comprises at least one of the following: a neighboring cell of a current serving cell before the UE executes CHO, or a neighboring cell of a current serving cell after the UE executes CHO; and
the measurement result comprises at least one of the following: Reference Signal Received (RSRP), Reference Signal Received Quality (RSRQ), or a Signal-to-Interference-plus-Noise Ratio (SINR).

7. The method according to claim 6, wherein the time comprises at least one of the following:
time at which the UE executes the CHO to the first cell;
time at which the UE completes execution of the CHO to the first cell; or
time at which the first trigger condition for at least one CHO candidate cell is satisfied, wherein the at least one CHO candidate cell comprises the first cell.

8. The method according to claim 6, wherein the second time is time represented by the second time interval that is after the first time; and
the first time interval is time elapsed from the first time to fourth time, and the fourth time comprises at least one of the following:
time at which the UE executes the CPA to a third cell;
time at which the UE executes the CPC to a fourth cell;
time at which the UE completes execution of the CPA to the third cell;
time at which the UE completes execution of the CPC to the fourth cell;
time at which the second trigger condition for the at least one CPA candidate cell is satisfied; or
time at which the third trigger condition for the at least one CPC candidate cell is satisfied, wherein
the third cell is a target cell to which the UE executes the CPA, and the fourth cell is a target cell to which the UE executes the CPC.

9. The method according to claim 6, wherein the CPA candidate cell is associated with the first cell, the CPC candidate cell is associated with the first cell, and the first cell is a target cell to which the UE executes the CHO.

10. The method according to claim 6, wherein the first timer comprises at least one of the following: a T310 timer or a T312 timer.

11. The method according to claim 6, wherein a satisfaction status of the second trigger condition for the CPA candidate cell comprises at least one of the following:
a 1^{st} event in the second trigger condition is satisfied first;
a 2^{nd} event in the second trigger condition is satisfied first;
time elapsed from time at which the 1^{st} event in the second trigger condition is satisfied to time at which the 2^{nd} event is satisfied; or
a difference between a first measurement result and the second trigger condition when the second trigger condition is not satisfied, wherein the first measurement result comprises a measurement result of the CPA candidate cell; and
a satisfaction status of the third trigger condition for the CPC candidate cell comprises at least one of the following:
a 1^{st} event in the third trigger condition is satisfied first;
a 2^{nd} event in the third trigger condition is satisfied first;
time elapsed from time at which the 1^{st} event in the third trigger condition is satisfied to time at which the 2^{nd} event is satisfied; or
a difference between a second measurement result and the third trigger condition when the third trigger condition is not satisfied, wherein the second measurement result comprises at least one of the following: a measurement result of a source primary secondary cell, or a measurement result of the CPC candidate cell.

12. The method according to claim 6, wherein the information about the first cell comprises at least one of the following:
a physical cell IDentifier (ID);
a cell ID;
a Cell Global Identity (CGI);
a 1^{st} network ID broadcast in the first cell; or
an ID of a tracking area to which the first cell belongs, wherein the ID of the tracking area is associated with the 1^{st} network ID broadcast in the first cell.

13. The method according to claim 6, wherein the second information further comprises any one of the following:
the second information obtained most recently before the first time;
the second information obtained most recently before the second time; or
the second information obtained most recently before third time.

14. The method according to claim 4, wherein the reporting second information to the first network side device comprises any one of the following:
when the first condition is satisfied, carrying the second information by using a CHO handover complete message;
when the first condition is satisfied, triggering a process of reporting SCG failure information, and carrying the second information by using the SCG failure information; or
when the first condition is satisfied, storing the second information into a first variable, and carrying the second information by using a first message based on an instruction of the first network side device,
wherein the storing the second information into a first variable, and carrying the second information by using a first message based on an instruction of the first network side device comprises:
storing the second information into the first variable;
sending tenth indication information to the first network side device, wherein the tenth indication information is used to indicate that there is available second information in the first variable; and
sending a first message to the first network side device when eleventh indication information sent by the first network side device is received, wherein the second information is carried by using the first message, and the eleventh indication information is used to instruct the UE to report the second information.

15. The method according to claim 4, wherein the second condition comprises at least one of the following:
the UE is configured with a first configuration;
the UE is configured to be required to report the third information;
the UE is enabled to report the third information;
at least one CPA candidate cell satisfies the second trigger condition, a fifth cell does not satisfy the first trigger condition, the CPA candidate cell is associated with the fifth cell, and the fifth cell is one of CHO candidate cells;
at least one CPC candidate cell satisfies the third trigger condition, a sixth cell does not satisfy the first trigger condition, the CPC candidate cell is associated with the sixth cell, and the sixth cell is one of CHO candidate cells;
the SCG fails;
a first timer used for the SCG has been started;
running duration of the first timer used for the SCG exceeds a second threshold;
the MCG fails;
a second timer for the MCG has been started; or
running duration of the second timer used for the MCG exceeds a third threshold,
wherein the first timer comprises at least one of the following: a T310 timer or a T312 timer, and the second timer comprises at least one of the following: a T310 timer or a T312 timer.

16. The method according to claim 6, wherein the third information comprises at least one of the following:
information about at least one seventh cell, wherein one seventh cell is a CPA candidate cell, and one seventh cell satisfies the second trigger condition;
information about at least one eighth cell, wherein one eighth cell is a CPC candidate cell, and one eighth cell satisfies the third trigger condition;
a satisfaction status of the first trigger condition for a fifth cell, wherein the fifth cell is a CHO candidate cell, and the fifth cell is associated with the seventh cells;
a satisfaction status of the first trigger condition for a sixth cell, wherein the sixth cell is a CHO candidate cell, and the sixth cell is associated with the eighth cells;
the first trigger condition for the fifth cell;
the first trigger condition for the sixth cell;
a measurement result of the fifth cell, wherein the measurement result comprises at least one of the following: Reference Signal Received Power (RSRP), Reference Signal Received Quality (RSRQ), or a Signal-to-Interference-plus-Noise Ratio (SINR);
a measurement result of the sixth cell, wherein the measurement result comprises at least one of the following: RSRP, RSRQ, or a SINR;
a measurement result of a neighboring cell of a current serving cell; or
information about a ninth cell, wherein the ninth cell is a primary cell connected to the UE when the third information is generated.

17. The method according to claim 16, wherein the third information further comprises any one of the following:
third information obtained most recently before the SCG fails;
third information obtained when the at least one CPA candidate cell satisfies the second trigger condition; or
third information obtained when the at least one CPC candidate cell satisfies the third trigger condition;
wherein information about one seventh cell comprises any one of the following:
a physical cell IDentifier (ID);
a cell ID;
a Cell Global Identity (CGI);
a 1^{st} network identifier broadcast in one seventh cell; or
an ID of a tracking area to which one seventh cell belongs, wherein the ID of the tracking area is associated with the 1^{st} network ID broadcast in one seventh cell; and
information of one eighth cell comprises at least one of the following:
a physical cell ID;
a cell ID;
a CGI;
a 1^{st} network ID broadcast in one eighth cell; or
an ID of a tracking area to which one eighth cell belongs, wherein the ID of the tracking area is associated with the 1^{st} network ID broadcast in one eighth cell;
wherein the satisfaction status of the first trigger condition for the fifth cell comprises at least one of the following:
a 1^{st} event in the first trigger condition is satisfied first;
a 2^{nd} event in the first trigger condition is satisfied first;
time elapsed from time at which the 1^{st} event in the first trigger condition is satisfied to time at which the 2^{nd} event is satisfied; or
a difference between a third measurement result and the first trigger condition when the first trigger condition is not satisfied, wherein the third measurement result comprises at least one of the following: a measurement result of the fifth cell, or a measurement result of a primary cell; and
the satisfaction status of the first trigger condition for the sixth cell comprises at least one of the following:
a 1^{st} event in the first trigger condition is satisfied first;
a 2^{nd} event in the first trigger condition is satisfied first;
time elapsed from time at which the 1^{st} event in the first trigger condition is satisfied to time at which the 2^{nd} event is satisfied; or
a difference between a fourth measurement result and the first trigger condition when the first trigger condition is not satisfied, wherein the fourth measurement result comprises at least one of the following: a measurement result of the sixth cell, or a measurement result of a primary cell;
wherein the measurement result of the neighboring cell comprises at least one of the following:
a signal measurement result of the neighboring cell, wherein the signal measurement result comprises at least one of the following: RSRP, RSRQ, or a SINR;
twelfth indication information, wherein the twelfth indication information is used to indicate whether the neighboring cell is a CHO candidate cell;
thirteenth indication information, wherein the thirteenth indication information is used to indicate whether the neighboring cell is a CPA candidate cell;
fourteenth indication information, wherein the fourteenth indication information is used to indicate whether the neighboring cell is a CPC candidate cell;
fifteenth indication information, wherein when the neighboring cell is a CHO candidate cell, the fifteenth indication information is used to indicate whether the neighboring cell satisfies the first trigger condition; when the neighboring cell is a CPA candidate cell, the fifteenth indication information is used to indicate whether the neighboring cell satisfies the second trigger condition; and when the neighboring cell is a CPC candidate cell, the fifteenth indication information is used to indicate whether the neighboring cell satisfies the third trigger condition;
a first association relationship, wherein the first association relationship is used to indicate an association relationship between the CHO candidate cell and the CPA candidate cell; or
a second association relationship, wherein the second association relationship is used to indicate an association relationship between the CHO candidate cell and the CPC candidate cell; and
wherein the information about the ninth cell comprises any one of the following:
cell identity related information of the ninth cell, wherein the cell identity related information comprises at least one of the following: a physical cell ID, a cell ID, a CGI, a 1^{st} network identity broadcast in the ninth cell, or an ID of a tracking area to which the ninth cell belongs, wherein the ID of the tracking area is associated with the 1^{st} network identity broadcast in the ninth cell; or
link status related information, wherein the link status related information comprises at least one of the following:
sixteenth indication information, wherein the sixteenth indication information is used to indicate that a second timer used for the MCG is running or has not been started;
seventeenth indication information, wherein the seventeenth indication information is used to indicate a running status of the second timer used for the MCG; or
eighteenth indication information, wherein the eighteenth indication information is used to indicate whether a radio link failure occurs in the ninth cell,
wherein the first timer comprises at least one of the following: a T310 timer or a T312 timer, and the second timer comprises at least one of the following: a T310 timer or a T312 timer.

18. The method according to claim 4, wherein the reporting third information to the first network side device comprises any one of the following:
when the second condition is satisfied, triggering a process of reporting SCG failure information, and carrying the third information by using the SCG failure information; or
when the second condition is satisfied, storing the third information into a second variable, and carrying the third information by using a second message based on an instruction of the first network side device,
wherein the storing the third information into a second variable, and carrying the third information by using a second message based on an instruction of the first network side device comprises:
storing the third information into the second variable;
sending nineteenth indication information to the first network side device, wherein the nineteenth indication information is used to indicate that there is available third information in the second variable; and
sending a second message to the first network side device when twentieth indication information sent by the first network side device, wherein the third information is carried by using the second message, and the twentieth indication information is used to instruct the UE to report the third information; and
wherein the third condition comprises at least one of the following:
the UE is configured with a first configuration;
the UE is configured to be required to report the fourth information;
the UE is enabled to report the fourth information; or
the MCG fails.

19. The method according to claim 4, wherein the fourth information comprises at least one of the following:
information about at least one tenth cell, wherein one tenth cell is a CPA candidate cell, and one tenth cell satisfies the second trigger condition;
information about at least one eleventh cell, wherein one eleventh cell is a CPC candidate cell, and one eleventh cell satisfies the third trigger condition;
a measurement result of a neighboring cell of a current serving cell;
related information of a source SCG link status when the UE executes the CHO to a first cell, wherein the first cell is a target cell to which the UE executes the CHO;
twenty-first indication information, wherein the twenty-first indication information is used to indicate whether the UE has executed the CPA;
twenty-second indication information, wherein the twenty-second indication information is used to indicate whether the CPA succeeds;
twenty-third indication information, wherein the twenty-third indication information is used to indicate whether the UE has executed the CPC;
twenty-fourth indication information, wherein the twenty-fourth indication information is used to indicate whether the CPC succeeds;
twenty-fifth indication information, wherein the twenty-fifth indication information is used to indicate whether the UE has executed primary secondary cell addition;
twenty-sixth indication information, wherein the twenty-sixth indication information is used to indicate whether the UE has executed primary secondary cell change;
twenty-seventh indication information, wherein the twenty-seventh indication information is used to indicate whether the primary secondary cell addition succeeds;
twenty-eighth indication information, wherein the twenty-eighth indication information is used to indicate whether the primary secondary cell change succeeds;
a satisfaction status of the second trigger condition for the CPA candidate cell when the fourth information is generated; or
a satisfaction status of the third trigger condition for the CPC candidate cell when the fourth information is generated, wherein
the CPA candidate cell is associated with the first cell, and the CPC candidate cell is associated with the first cell,
wherein the fourth information further comprises at least one of the following:
the fourth information obtained during a most recent MCG failure;
the fourth information obtained during a CHO failure; and
the fourth information obtained during each of two CHO failures,
wherein information about one tenth cell comprises at least one of the following:
a physical cell IDentifier (ID);
a cell ID;
a Cell Global Identity (CGI);
a 1^{st} network ID broadcast in one tenth cell; or
an ID of a tracking area to which one tenth cell belongs, wherein the ID of the tracking area is associated with the 1^{st} network ID broadcast in one tenth cell; and
information about one eleventh cell comprises at least one of the following:
a physical cell ID;
a cell ID;
a CGI;
a 1^{st} network ID broadcast in one eleventh cell; or
an ID of a tracking area to which one eleventh cell belongs, wherein the ID of the tracking area is associated with the 1^{st} network ID broadcast in one eleventh cell; and
wherein the related information of the source SCG link status when the UE is indicated to execute the CHO to the first cell comprises at least one of the following:
information indicating that a source SCG fails or does not fail when the UE executes the CHO to the first cell;
information indicating that a first timer used for the SCG is running or has not been started when the UE executes the CHO to the first cell; or
information indicating a running status of the first timer used for the SCG when the UE executes the CHO to the first cell, wherein
the first timer comprises at least one of the following: a T310 timer or a T312 timer.

20. The method according to claim 4, wherein the reporting fourth information to the first network side device comprises any one of the following:
sending a Radio Link Failure (RLF) report to the first network side device, wherein the RLF report comprises the fourth information; or
sending an information response message to the first network side device, wherein a first domain of the information response message comprises the fourth information.
